(19) United States
(12) Patent Application Publication
(10) Pub. No.: US 2026/0362290 A1
(43) Pub. Date: Nov. 12, 2026

(54) Multiple Relay Session Management

(71) Applicant: Ofinno, LLC, Reston, VA (US)

(72) Inventors: SungDuck Chun, Fairfax, VA (US); Kyungmin Park, Vienna, VA (US); Esmael Hejazi Dinan, McLean, VA (US); Henrik Andreas Normann, Malmö (SE); Peyman Talebi Fard, Vienna, VA (US)

(73) Assignee: Ofinno, LLC, Reston, VA (US)

(21) Appl. No.: 19/724,614

(22) Filed: Jun. 29, 2026

Related U.S. Application Data
(63) Continuation of application No. PCT/US2025/011108, filed on Jan. 10, 2025.
(60) Provisional application No. 63/619,498, filed on Jan. 10, 2024.

(51) Int. Cl. H04W 40/22; H04W 28/02; H04W 88/04; H04W 92/18

(52) U.S. Cl. CPC H04W 40/22; H04W 28/0205; H04W 88/04; H04W 92/18

(57) ABSTRACT

A first wireless relay device receives, from a first wireless device, a message, indicating a first internet protocol (IP) address of the first wireless device for multihop relaying and a device identifier of the first wireless device. The first wireless device is connected to a second wireless device, via the first relay wireless device and a second relay wireless device, using the multihop relaying. The first wireless relay device sends, to the second relay wireless device and based on the receiving, one or more parameters comprising the first IP address and the device identifier

### CROSS-REFERENCE TO RELATED APPLICATIONS

This application is a continuation of International Application No. PCT/US2025/011108, filed Jan. 10, 2025, which claims the benefit of U.S. Provisional Application No. 63/619,498, filed Jan. 10, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

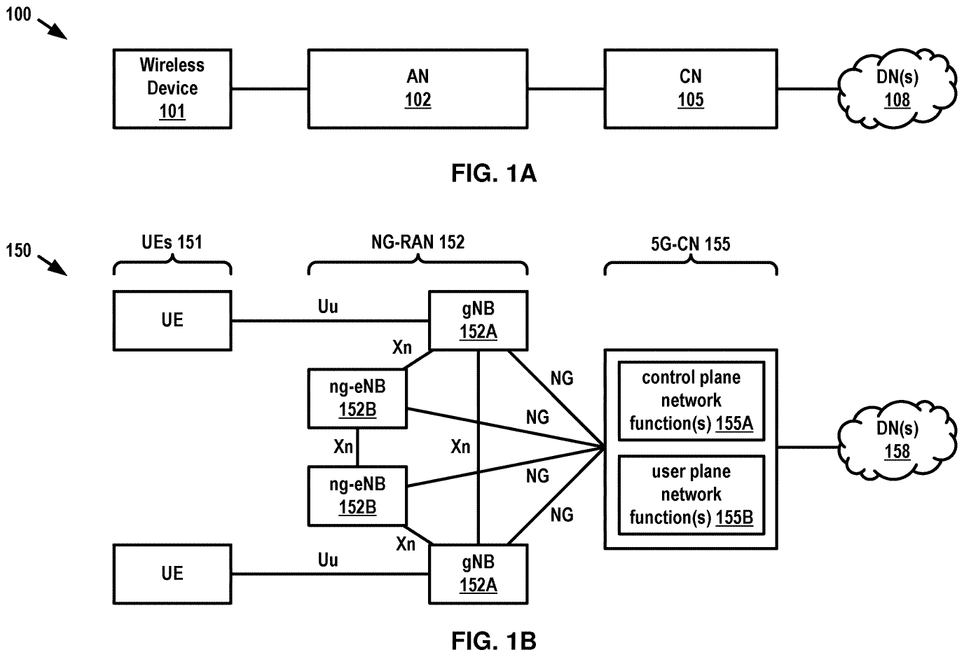

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

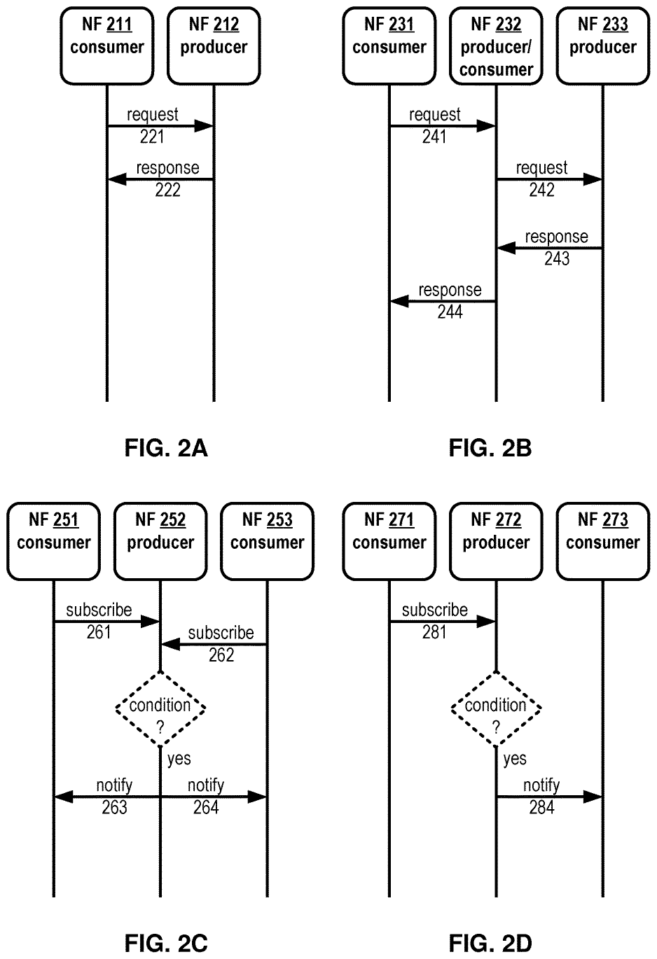

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

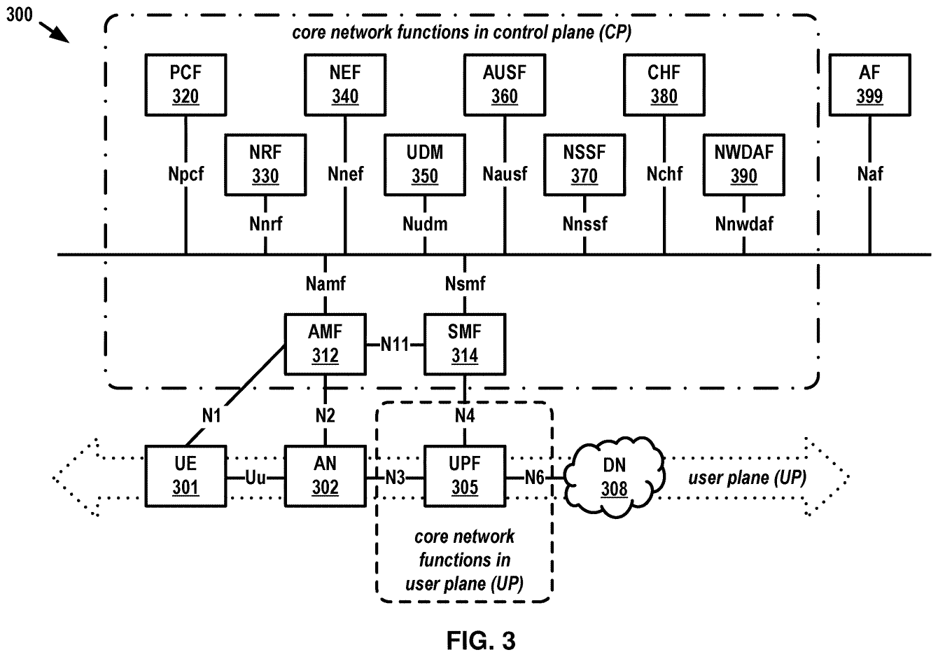

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

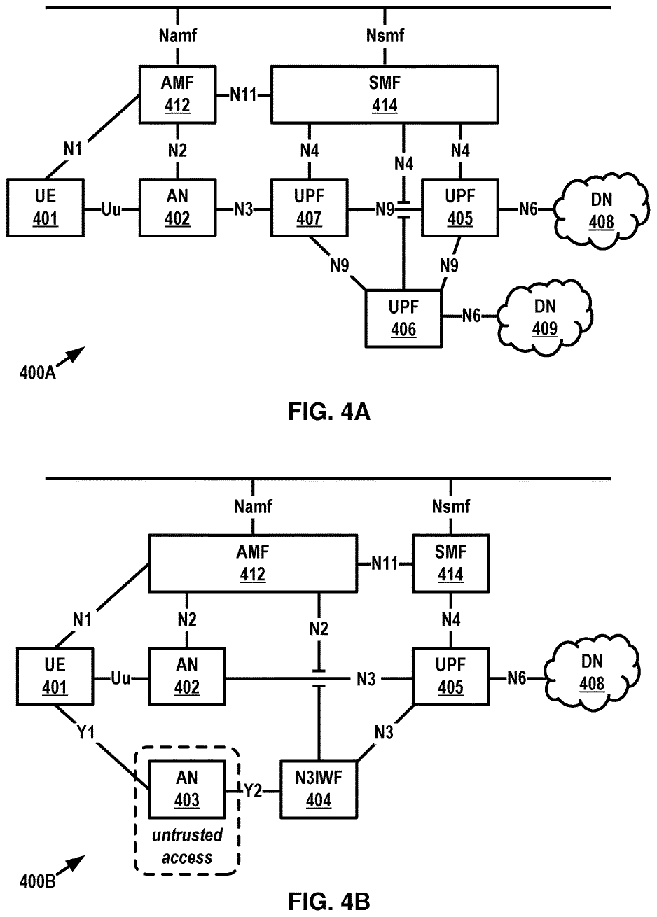

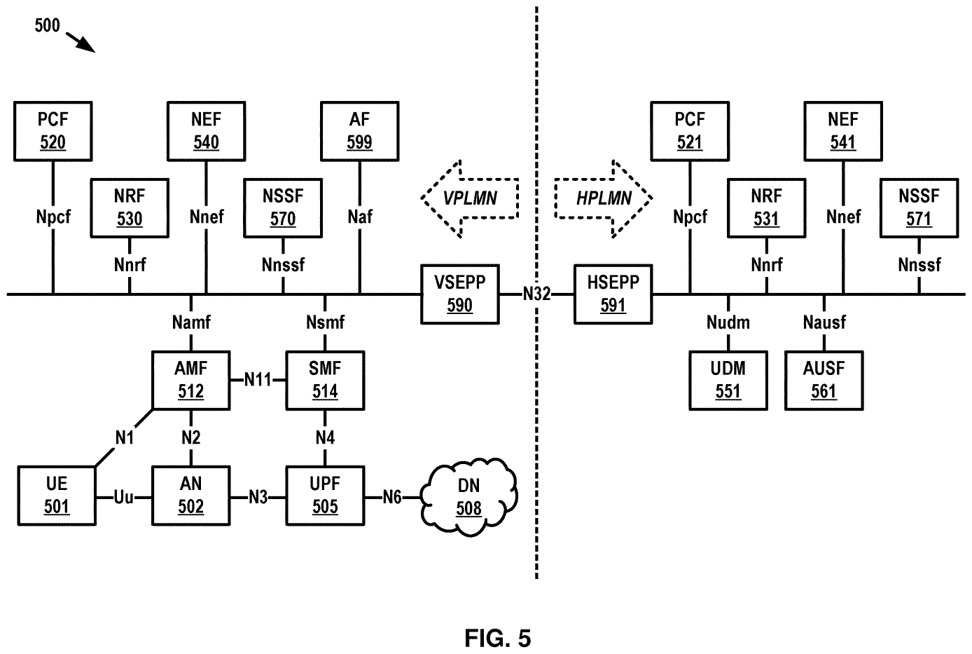

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

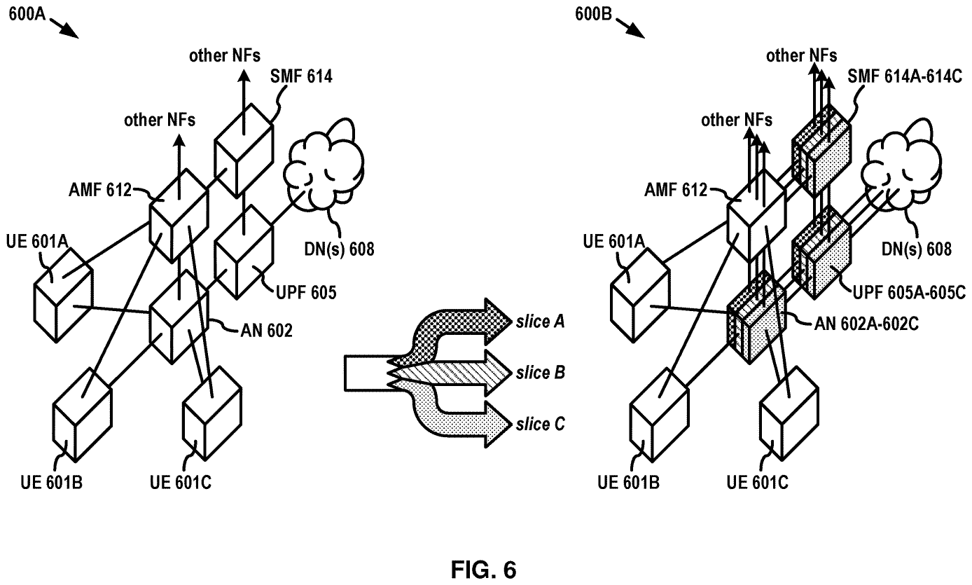

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

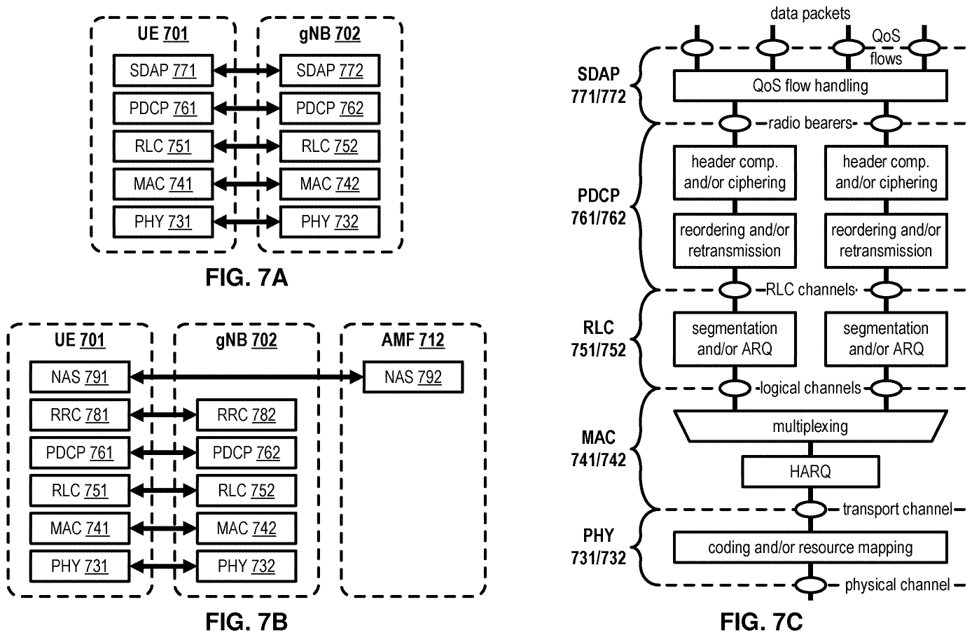

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

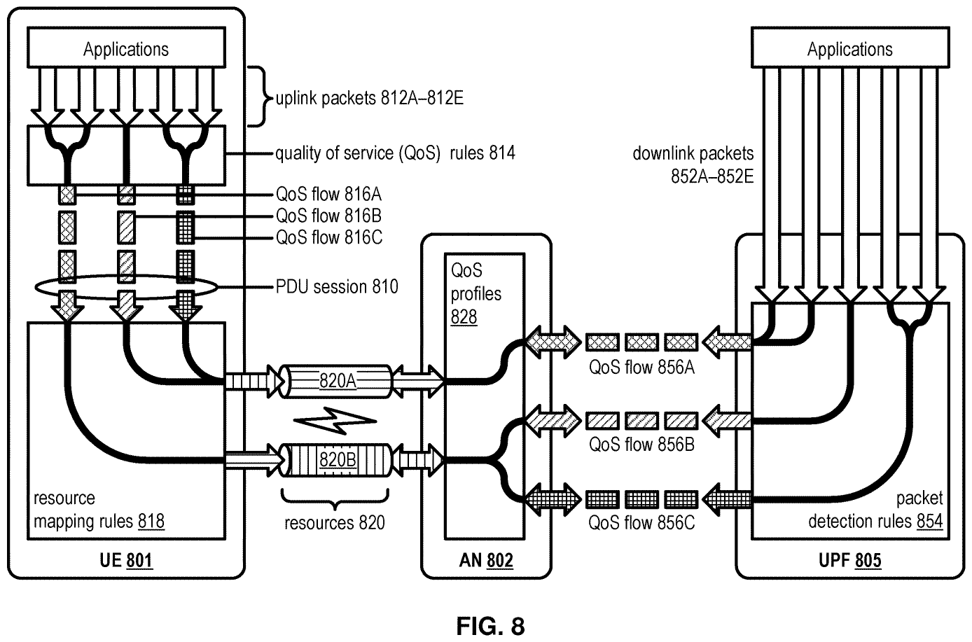

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

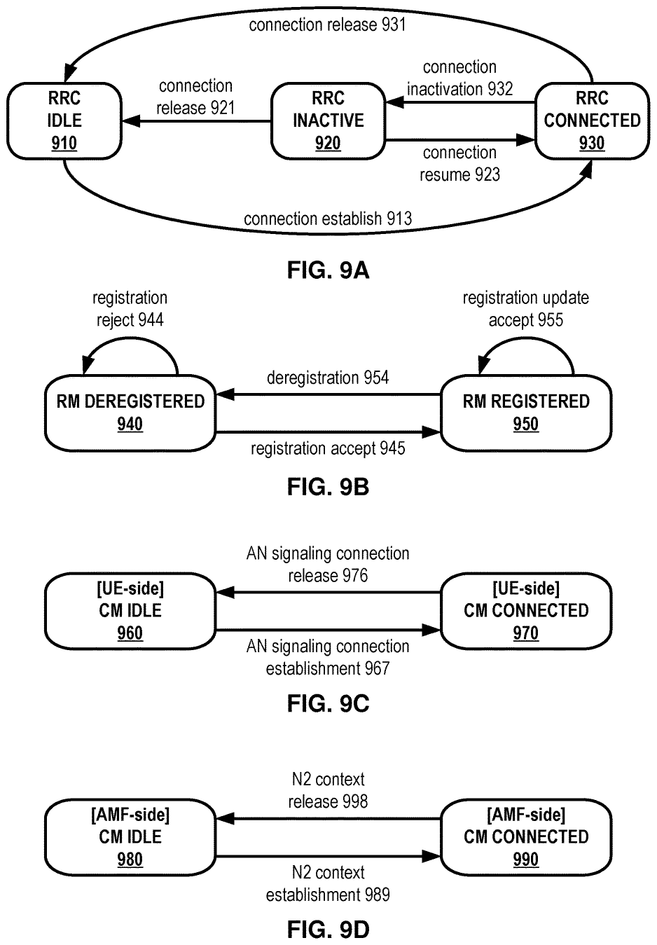

FIG. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC _IDLE), RRC inactive 920 (e.g., RRC _INACTIVE), or RRC connected 930 (e.g., RRC _CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network,. e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

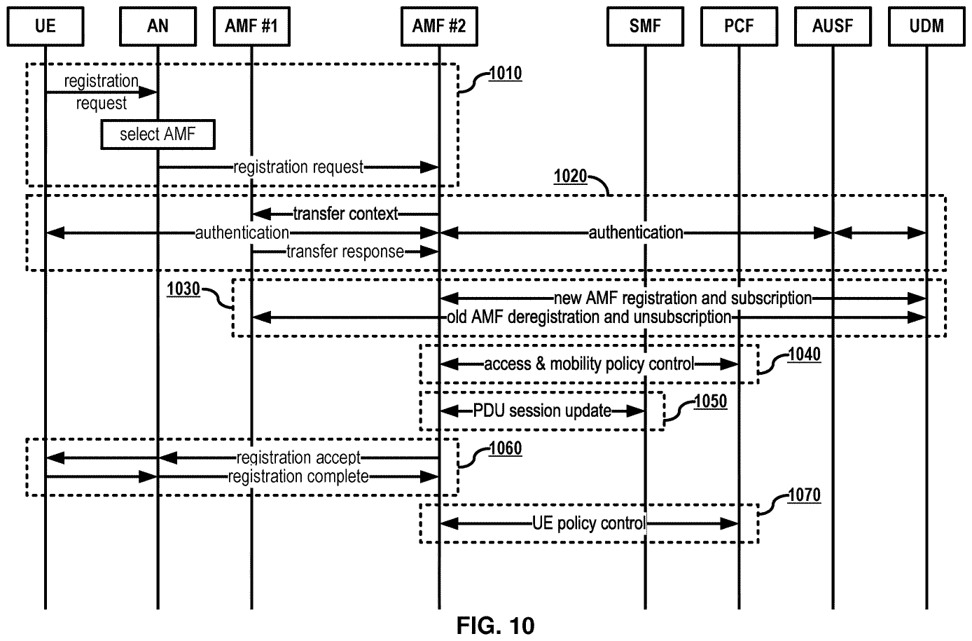

FIG. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_ Communication_ UEContextTransfer message. AMF #1 may send to AMF #2 a message that includes the requested UE context. This message may be a Namf_ Communication_ UEContextTransfer message. After the UE context is received, the AMF #2 may coordinate authentication of the UE. After authentication is complete, AMF #2 may send to AMF #1 a message indicating that the UE context transfer is complete. This message may be a Namf_ Communication_ UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_ UECM). AMF #2 may obtain subscription information of the UE using a subscriber data management service of the UDM (Nudm_ SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_ PDUSession_ ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

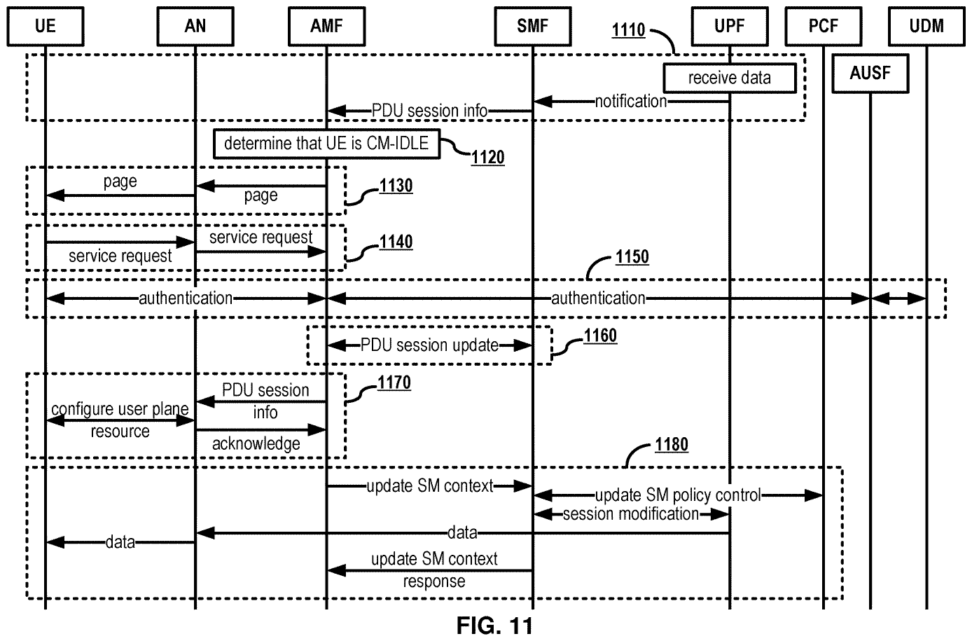

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

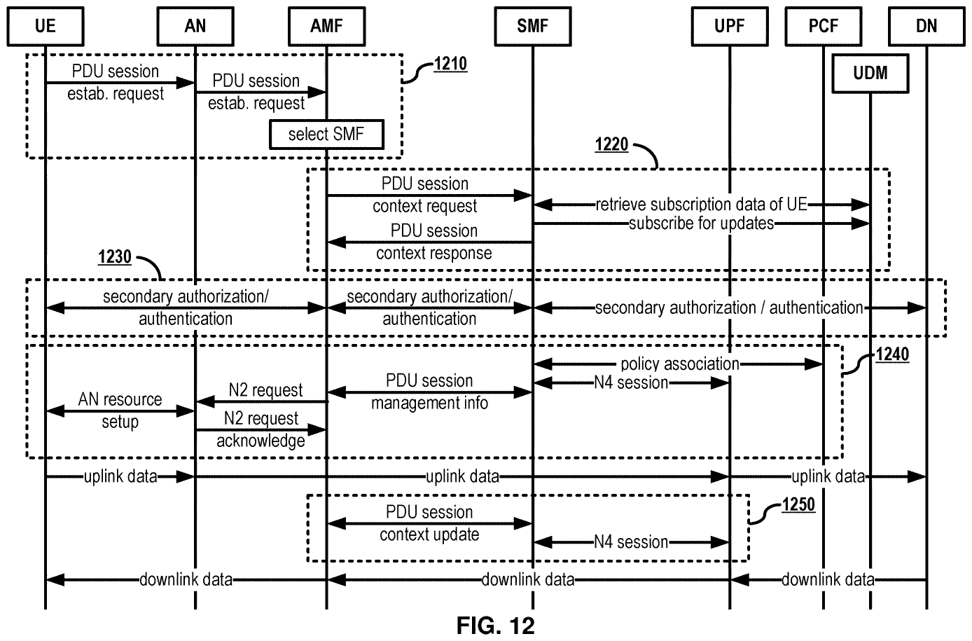

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_ PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_ PDUSession_ CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

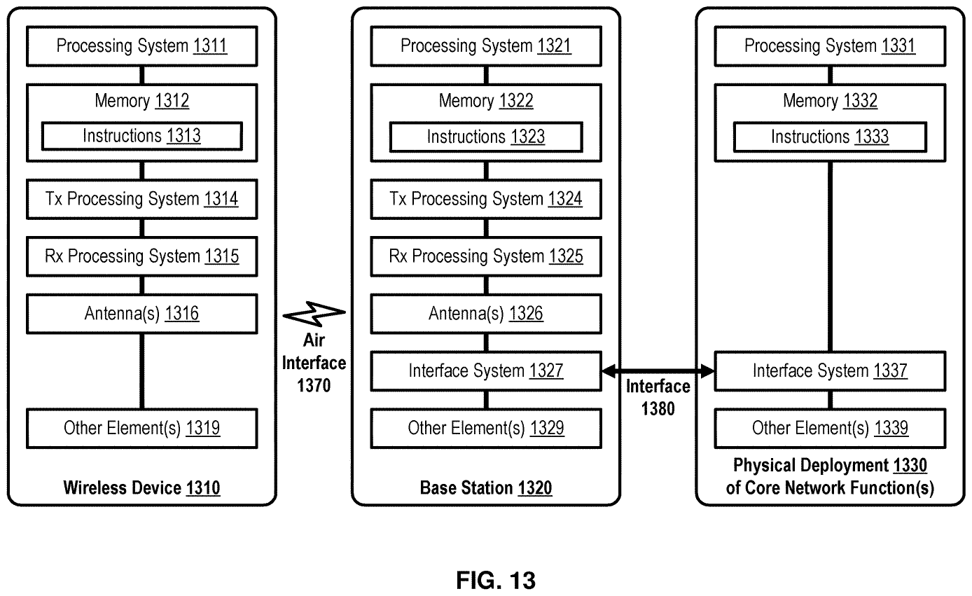

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

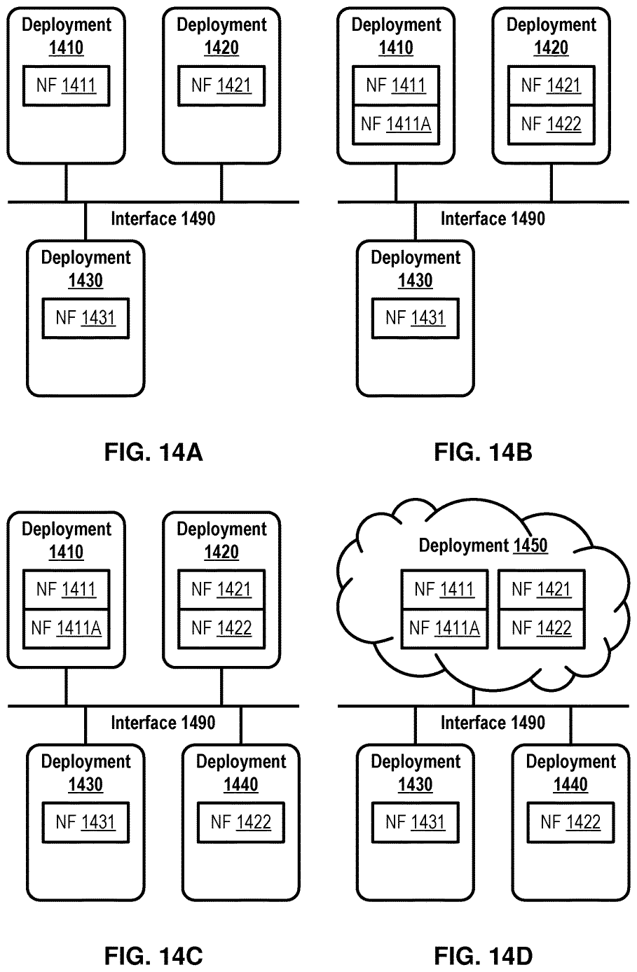

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

One of advancement achieved by 5G system (5GS) may be to use a new frequency band that was not actively used in previous generation communication system. For example, as device components of mobile communication system begin to support higher frequencies (e.g., milli-meter waves), the 5G system can support a higher bitrate via the higher frequencies.

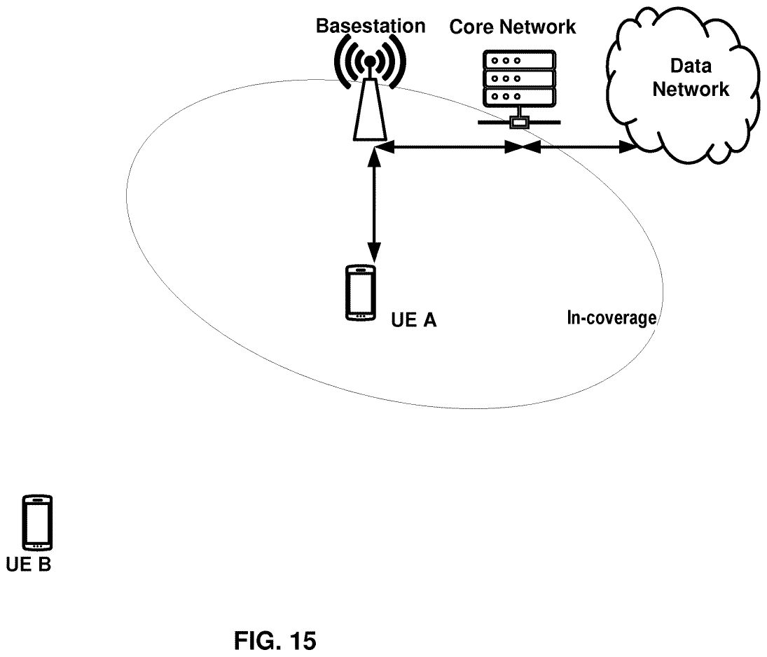

However, one of problems of using the higher frequencies includes that communication range supported by the higher frequencies is shorter than communication range supported by lower frequencies (e.g., centi-meter waves). As shown in the example of FIG. 15, as long as a mobile device (e.g., UE A) of a user is located inside a coverage (e.g., a signal strength of a basestation is above minimum threshold that can sustain a communication) of a cell, the user (e.g., UE A) can enjoy a higher data bitrate service. However, as communication range supported by the cell gets shorter due to use of the higher frequencies, another user (e.g., UE B) may be more likely to be located outside of the coverage of the cell, and communication service may not be provided to the another user. This may lead to reduced availability of communication service by the 5G system, and more interruptions to the communication service.

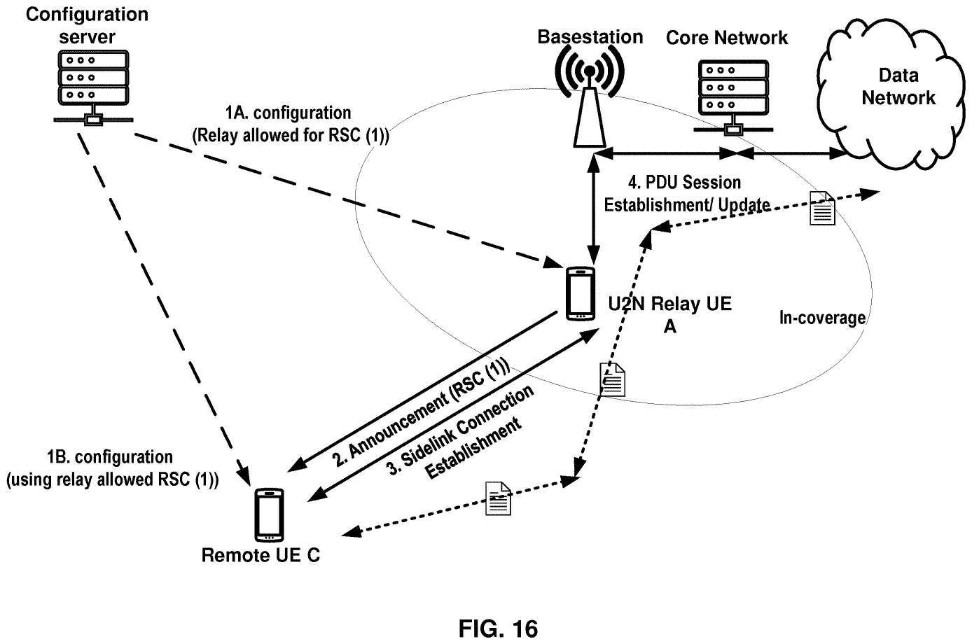

As shown in the example depicted in FIG. 16, a remote UE (e.g., remote C, remote UE C) may benefit from using a sidelink communication (e.g., PC5 communication) via a relay UE (e.g., relay A, e.g., a wireless relay device, a relay wireless device). In an example, a user of the remote UE may decide to use the relay UE. For example, when the remote UE is outside of a coverage of a base station, the remote UE (e.g., remote wireless device) may not be able to communicate directly (e.g., not using another UE in the middle) with one or more cells of the base station. Based on that the remote UE being unable to directly communicate with the base station, the user of the remote UE may decide to use a relay service (e.g., data communication between the remote UE and a network (e.g., an application server, the basestation, a UPF, and/or the like) via one or more relay UEs). To use the relay service, the remote UE may start searching for candidate relay UEs. For example, the remote UE may be configured with a first relay policy information by a configuration server (e.g., a PCF, an AF, an AMF, a SMF, and/or the like). For example, the first relay policy information may indicate (comprise) at least one of one or more relay service codes (RSCs) (e.g., RSC 1) allowed for the remote UE, an indication (e.g., authorization information) indicating whether the remote UE is allowed to use a relay service from a relay UE. Similarly, the relay UE may be configured with a second relay policy information by the configuration server. For example, the second relay policy information may indicate (comprise) at least one of the one or more relay service codes (e.g., RSC 1) allowed for the relay UE, and/or a second indication indicating whether the relay UE is allowed to provide one or more relay services (associated with the RSCs) to a remote UE. The remote UE may find one or more candidate relay UEs that can relay data traffic between the base station and the remote UE. For example, the relay UE may send a sidelink announcement message (e.g., sidelink announce message, e.g., a Prose PC5 discovery message for announcement). For example, based on that the relay UE is allowed to provide the one or more relay services, the sidelink announcement message may comprise the one or more RSCs. In an example, the remote UE may receive the sidelink announcement message. Based on the first relay policy information comprising the RSC 1, and/or based on that the sidelink announcement message comprising the RSC 1, the remote UE may determine that the remote UE can use the relay UE for the relay service (e.g., a relay service 1 associated with the RSC 1). The remote UE may select the relay UE among one or more found candidate relay UEs. For example, the remote UE may establish a sidelink connection (e.g., by sending/receiving a prose direct link connection request and/or by receiving/sending a prose direct link connection accept, and/or the like) with the relay UE. In an example, based on that the relay UE establishes the sidelink connection with the remote UE and/or based on that the remote UE indicates the RSC 1, the relay UE may establish (sending/receiving a PDU session establishment/modification message) with a SMF, a PDU session associated with the RSC 1, with the network. After the PDU session is established, the relay UE may receive one or more packets sent by the remote UE and/or may deliver the one or more packets to the network (e.g., base station, UPF). By using communication link between the remote UE and the relay UE and communication link between the relay UE and the base station, data traffic can be exchanged between the remote UE and the application server. However, this mechanism may not be able to support communication for the remote UE enough, when the one or more found candidate relay UEs are located outside of the coverage of the cell (e.g., cannot directly connect to the cell (e.g., the basestation)).

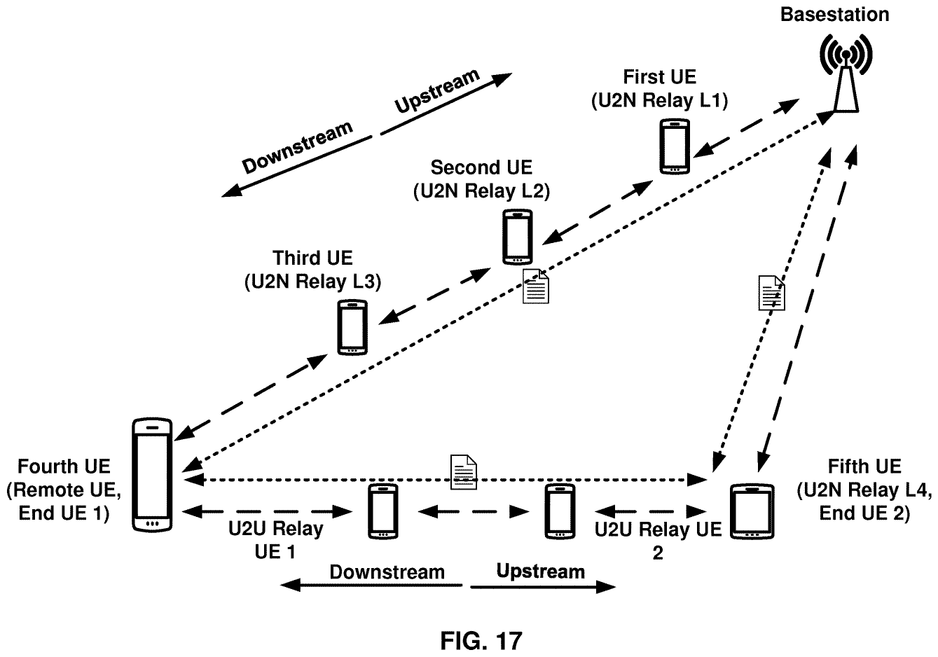

FIG. 17 depicts one example embodiment of the present disclosure. For example, each UE may perform one or more roles. For example, a multihop U2N relaying may be supported using one or more U2U relay UEs and/or one or more U2N relay UEs.

In an example, a first UE (e.g., U2N relay L1) may perform as one of upstream relay UEs for a second UE (e.g., U2N relay L2) or for a third UE (e.g., U2N relay L3). The first UE may perform as an edge U2N relay UE, as a topmost edge U2N relay UE, as a topmost U2N relay UE, and/or the like. For example, the first UE may have a direct (network) connection with a basestation.

In an example, the second UE (e.g., U2N relay L2) may perform as one of upstream relay UEs for the third UE (e.g., U2N relay L3). The second UE may perform as one of downstream relay UEs for the first UE. The second UE may perform as one of interim relay UEs between a fourth UE and the first UE.

In an example, the third UE (e.g., U2N relay L3) may not perform as one of upstream relay UEs for other relay UEs and/or may perform as one of upstream relay UEs for a remote UE. The third UE may perform as one of downstream relay UEs for the first UE and/or for the second UE. The third UE may perform as an edge U2N relay UE, as a bottommost edge U2N relay UE, as a bottom U2N relay UE, and/or the like.

In an example, the remote UE may use a multihop U2N relay services via one or more U2N relays (e.g., U2N relay L1, U2N relay L2, U2N relay L3). For example, a data packet sent by the remote UE 1 may be forward through a first path comprising the U2N relay L3, the U2N relay L2, the U2N relay L1 and the basestation.

Alternatively and additionally, a fourth UE (e.g., remote UE, end UE 1) may establish a U2U connection to a fifth UE (e.g., end UE 2, U2N relay L4) via one or more U2U relay UEs (e.g., U2U relay 1, U2U relay 2). For example, the fourth UE may send a data packet to the fifth UE via the one or more U2U relay UEs. For example, the one or more U2U relay UEs may transport the data packet between the fourth UE and the fifth UE. For example, the fifth UE may support U2N relay functionality. In this case, the fifth UE may deliver the data packet (received from the fourth UE via the one or more U2U relay UEs) to the basestation (or the network). In this case, the one or more U2U relay UEs and/or the fifth UE may jointly support multihop U2N relaying, and/or may functions as multihop relays. For example, a path between the fourth UE and the fifth UE may be considered as multihop U2U relaying path. For example, by combining the multihop U2U relaying path with a U2N relaying, multihop U2N relaying can be provided to the fourth UE. For example, the data packet sent by the fourth UE (remote UE 1, the end UE 1) may be forwarded through a second path comprising the U2U relay 1, the U2U relay 2, and the basestation.

In an example, a UE may assume multiple roles. For example, from the fifth UE point of view, the fourth UE may be considered as a remote UE (because the fourth UE sends a data packet targeted to a network) and/or as a end UE (because the fourth UE is connected to the fifth UE via a U2U relaying). For example, if the third UE has a second data packet to send to the network, the third UE may also be considered as a remote UE.

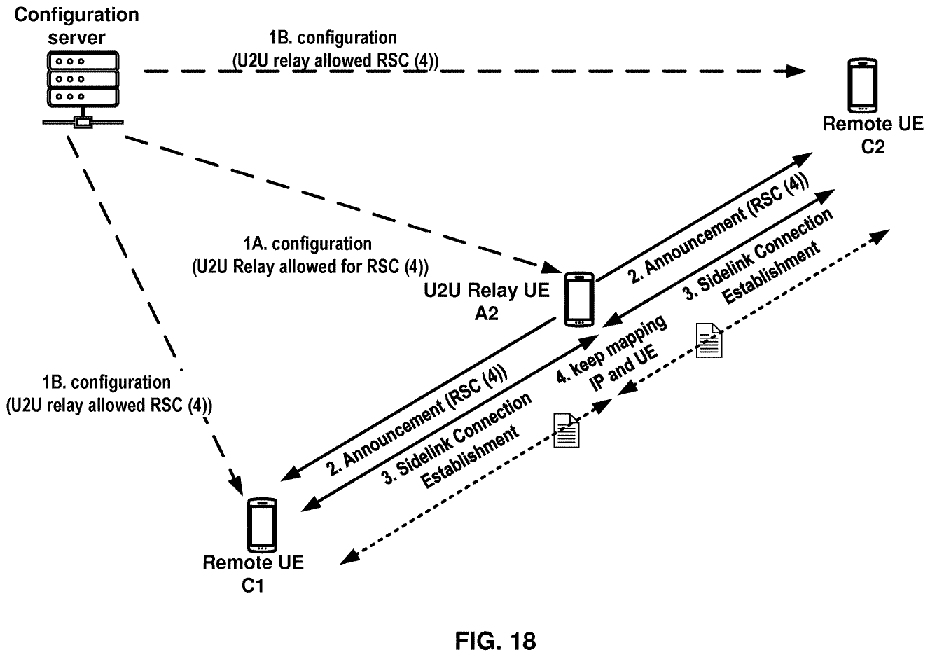

In an example as depicted in FIG. 18, one or more end UEs (e.g., end UE C1, end UE C2) may be able to communicate with each other by using one or more U2U relay UEs. For example, a U2U relay A2 may be configured by a configuration server (e.g., prose application server, AMF, PCF, and/or the like) for U2U relaying operation. For example, the configuration server may send a NAS message 1A (e.g., step 1A), to configure the U2U relay A2. For example, the NAS message 1A may comprise a prose policy information for U2U relaying operation. For example, the NAS message 1A may indicate (e.g., comprise an indication indicating) that the U2U relay A2 is allowed to act (e.g., perform, behave) as a U2U relay, and/or one or more RSCs (e.g., RSC 4) indicating (allowing, authorizing) a U2U relaying service (e.g., U2U relaying operation).

In an example, a similar method used for configuring the U2U relay A2 may be used for configuring the end UE C2 and/or the end UE C1. For example, the configuration server may send a NAS message 1B to the end UE C1 and/or to the end UE C2. For example, the NAS message 1B may have similar contents and/or a similar structure as the NAS message 1A. For example, the NAS message 1B may indicate that the end UE C2 (and/or the end UE C1) is allowed to act as an end UE of U2U relaying operation, and/or one or more RSC (e.g., RSC 4) indicating (allowing, authorizing) the U2U relaying service.

In an example, because the U2U relay A2 is allowed for U2U relaying operation, the U2U relay A2 may send a sidelink message 2 (e.g., step 2) to one or more UEs. For example, the sidelink message 2 may be a PC5 message 2. The sidelink message 2 may be at least one of Announce message (e.g., Prose Discovery message for announcement), ProSe Additional Parameters Announcement Response message, ProSe PC5 Discovery message, ProSe Direct Link Establishment message, ProSe Direct Link Modification message, and/or the like. For example, the sidelink message 2 may comprise the RSC 4.

In an example, the end UE C2 and/or the end UE C1 may receive the sidelink message 2. Because the end UE C2 (similarly the end UE C1) is allowed for using U2U relaying service and/or because the end UE C2 (similarly the end UE C1) is configured with the RSC 4, the end UE C2 (similarly the end UE C1) may determine that the end UE C2 (similarly the end UE C1) is allowed to use/access the U2U relay A2. Based on the determination, the end UE C2 (similarly the end UE C1) may establish a sidelink connection (e.g., by sending a PC5 Prose Direct connection request and/or by receiving a PC5 Prose Direct connection accept) with the U2U relay A2, for U2U communication/relaying. For example, via the U2U relay A2, the end UE C1 and the end UE C2 may establish a U2U connection with each other. For example, over the established U2U connection, the end UE C1 may send a packet targeting (e.g., content of the packet is processed by) the end UE C2, to the end UE C2 via the U2U relay A2. For example, over the established U2U connection, the end UE C2 may send a second packet targeting the end UE C1, to the end UE C1 via the U2U relay A2.

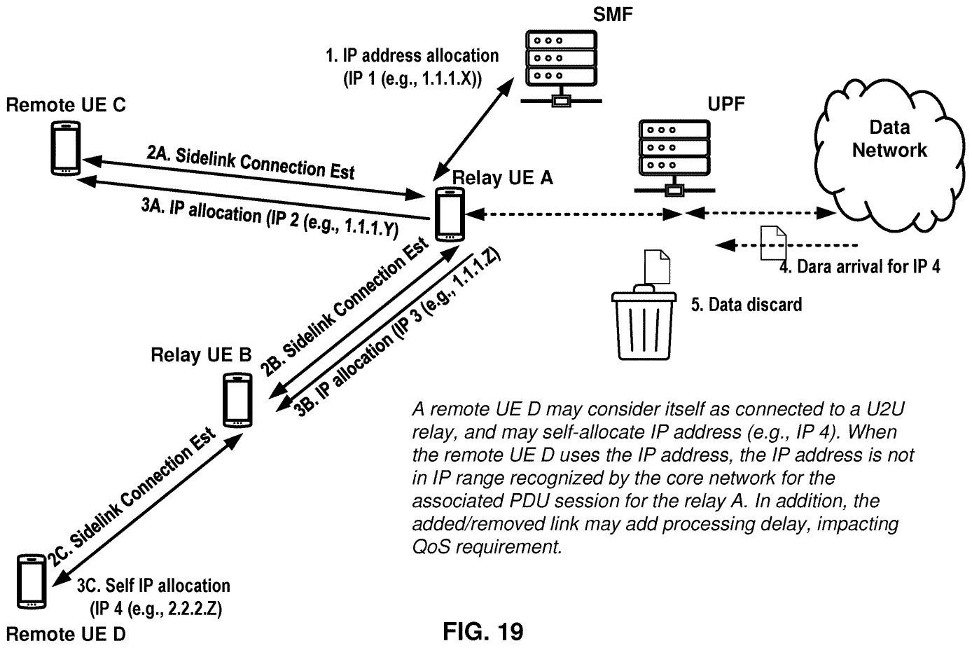

In an example as depicted in FIG. 19, a plurality of relay UEs may be used to provide a connectivity service for a remote UE.

In an example, a relay UE A (e.g., one of upstream relay UEs, relay A) may establish a connection to a network (e.g., a basestation, a UPF, a data network, and/or the like, e.g., a PDU session). For example, the relay UE A may be located inside a coverage area and/or the relay UE A may be located in area where the relay UE A is allowed to participate in (and/or to provide) multihop relaying operation. For example, the connection to the network may be a direct network connection (e.g., the relay UE A is connected to the network (e.g., basestation) without any other UE in the middle, e.g., Uu interface) and/or an indirect network connection (e.g., the relay UE A is connected to the network via other one or more UEs in the middle). In an example, the relay UE A may establish the PDU session. For example, the PDU session may be used for relaying a traffic between a downstream UE (e.g., a downstream relay UE, a downstream remote UE, a downstream end UE, and/or the like) and the network. For example, the relay UE A may send a request (e.g., request additional prefixes, addresses) to a core network node. For the PDU session, the core network node (e.g., a SMF, a UPF) may allocate one or more IP addresses (e.g., PDU address IE, IPv4 address, interface identifier for IPv6 link local address, additional prefixes) and/or one or more IP ranges (e.g., one or more IP prefixes, IPv4 address, interface identifier for IPv6 link local address, additional prefixes) for the PDU session (and/or for the relay UE A, for a RSC). For example, the core network node may send a management message to the relay UE A. For example, the management message may be at least one of a session management message (e.g., a PDU session establishment/ modification message) and/or a DHCP message (e.g., DHCPv6 reply). For example, the management message may indicate the one or more IP addresses (e.g., IP prefixes) and/or the one or more IP ranges. In an example, the relay UE A may receive the management message.

In an example, a remote UE C (e.g., remote C, remote wireless device C) may establish (e.g., step 2A) a first sidelink connection (e.g., a connection using a PC5 interface, a sidelink connection for U2N relaying) with the relay A. After establishing the first sidelink connection and/or during establishment of the first sidelink connection, the relay UE A may indicate to the remote UE C, an assigned IP address (e.g., an IP address 2 (1.1.1.Y), or locally network address translated (NATed) IP address (e.g., 192.168.0.K)). For example, because the relay UE A is providing a U2N relaying service, the relay UE A may determine to indicate the assigned IP address to the remote UE C and/or the remote UE C may determine to receive/ request from the relay UE A, the assigned IP address.

In an example, if the relay UE B is outside of a coverage of a cell and/or if the relay UE A is able to provide relaying service to the relay UE B for multihop, the relay UE B may establish (e.g., step 2B) a second sidelink connection to the relay A. Alternatively and/or additionally, a remote UE D may be located outside of the coverage, and/or the remote UE D may be authorized to establish a U2U connection (e.g., U2U relaying connection). For example, the remote UE D may establish a third sidelink connection (e.g., step 2C) to the relay UE B. For example, based on receiving from the remote UE D a request for the U2U relaying connection, the relay UE B may determine to establish the second sidelink connection with the relay UE A. After establishing the U2U relaying connection (e.g., between the remote UE D and the relay UE B, between the remote UE D and the relay UE A, and/or the like), because the remote UE D establishes the U2U relaying connection, the remote UE D may determine to self-assign a fourth IP address (e.g., IP 4 (2.2.2.2)) to the remote UE D. After establishing the U2U relaying connection for the remote UE D and/or the relay UE A, the relay UE B may determine to self-assign a third IP address to the relay UE B and/or may receive a third IP assignment of the third IP address (e.g., IP 3 (1.1.1.Z)), from the relay UE A.

In an example, based on the fourth IP address (e.g., the IP 4) being available, the remote UE D may send a first IP packet to the relay A via the relay B. For example, a source IP address of the first IP packet may indicate (e.g., comprise, comprise an information indicating) the IP 4. In an example, the relay UE A may receive the first IP packet from the remote UE D via the relay UE B. Based on the PDU session being available, the relay UE A may determine to forward the first IP packet to the network via the PDU session. For example, the UPF may forward the first IP packet to an application server indicated by a target IP address of the first IP packet.

In an example, the UPF may receive a second IP packet. For example, the second IP packet may be sent by the application server, in response to receiving the first IP packet. Because the first IP packet indicates IP 4 (2.2.2.2) as the source IP address, a target IP address of the second IP packet may indicate IP 4. In an example, the UPF may determine which PDU session is associated with the second IP packet. For example, the UPF may check one or more IP addresses assigned to one or more PDU sessions which the UPF handles. For example, because the UPF (and/or the SMF) does not assign IP 4, because IP 4 is not assigned to the one or more PDU session, the UPF may determine that there is no UE (or PDU session) associated with the second IP packet and/or may determine to discard the second IP packet. Thus, in existing technologies, a remote UE (and/or an end UE) may use an address not recognized by a network node. When one or more IP packets of the remote UE are generated for communication with a remote server (e.g., an application server, a data network, etc.), the address not recognized by the network node may cause discarding of the one or more IP packets. This may cause waste of sidelink radio resources, incorrect charging information, and/or service quality degradation.

In example embodiments of the present disclosure, signalling may be enhanced to deliver one or more UE address information to one or more downstream relay UEs for multihop relaying. This may assist a downstream UE to determine a UE address for reliably communicating with a network and/or for a downstream relay UE to determine how to process one or more received packets in a topology of UEs. In other examples, signalling may be enhanced to report the one or more addresses of one or more downstream UEs to a network node. This may assist the network node in determining whether to forward a received packet, and to which relay UE the received packet is delivered. In other examples, signalling may be enhanced between an edge relay UE and an end UE for a U2U relay operation. This may help for the edge relay UE to manage a connection toward the end UE and to manage a UE address for proper delivery of packets. In other examples, in the topology of UEs, one or more UEs may exchange information of an entity assigning UE addresses. This may help the one or more UEs to determine whether to request assignment of the UE addresses or not. In other examples, one or more downstream UEs may be indicated to a core network node. This may help the core network node for proper routing.

In the specification, the term “5G access network” may be interpreted as, or may refer to, an access network comprising at least one of a NG-RAN and/or non-3GPP access network (AN), and connecting to a 5G core network.

In the specification, the term “5G core network” may be interpreted as, or may refer to, a core network connecting to a 5G access network. This may be 5G core (5GC).

In the specification, the term “3GPP RAN” or “RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, the like, and/or a combination thereof.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “network node” may be interpreted as, or may refer to, at least one of a core network node, an access node, a UE, the like, and/or a combination thereof. A network may comprise one or more network nodes.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW-C, a SMF+PGW-U, a UDM+HSS and/or the like.

In the specification, a term of a relay UE (a relay wireless device, a wireless relay device, a relay, and/or the like) may be interpreted as a U2N relay UE and/or a U2U relay UE. The relay UE may be a relay. The relay UE may be 5G Prose Relay UE.

In the specification, a term of a UE-to-Network (U2N) relay UE may be interpreted as a UE which provides a network relay service (e.g., UE-to-Network service, e.g., a data delivery from/to a network (e.g., application server, data network)) for a remote UE and/or a downstream UE (e.g., a downstream end UE, a downstream relay UE, a downstream remote UE). The U2N relay UE may be a U2N relay and/or 5G ProSe UE-to-Network Relay UE. The U2N relay UE may provides functionality to support connectivity to a network (e.g., an application server, a basestation, a UPF, a data network, and/or the like) for the downstream UE. For example, connectivity to the network for the downstream UE may be providing data delivery service of data between the downstream UE and the network (e.g., basestation, a UPF, a data network). The U2N relay UE may comprise at least a singlehop (e.g., basic) U2N relay UE and/or a multihop (e.g., evolved, advanced) U2N relay UE. The singlehop U2N relay may be directly connected to the network (e.g., direct network connection) and/or may be directly connected to the remote UE. The multihop U2N relay may be connected to the network via one or more first UEs (e.g., another first U2N relays, and/or another first U2U relays, and/or upstream relay UEs) and/or may be connected to the remote UE via one or more second UEs (e.g., another second U2N relays, and/or another second U2U relays, and/or downstream relay UEs). The U2N relay UE may comprise at least one of an edge U2N relay UE and/or interim U2N relay UE. For example, the edge U2N relay UE may directly connect to the remote UE without any UE in the middle and/or may directly connects to the cell (e.g., basestation, network) without any UE in the middle. For example, the edge U2N relay UE may comprise a first-type edge U2N relay UE (e.g., connects to directly the cell, a top relay UE) and/or a second-type edge U2N relay (e.g., connects to directly to a remote UE, a bottom relay UE). For example, the interim U2N relay UE may be a U2N relay UE which does not directly connect to the cell and/or which does not directly connect to a remote UE. An upstream relay UE may be a relay UE closer to the cell in a chain of relay UEs, and/or a downstream relay UE may be a relay UE closer to the remote UE (e.g., end UE) in the chain of relay UEs. For example, an upstream UE may be a UE closer to the cell in a chain of UEs and/or a downstream UE is a UE closer to a remote UE (e.g., an end UE) closer in a chain of UEs.

In the specification, a term of a UE-to-UE (U2N) relay UE may be interpreted as a UE which provides a UE-to-UE relay service (e.g., U2U service, a data delivery between two UEs without traversing a network/a cell/a basestation) for a remote UE (an end UE). The U2U relay UE may be a U2U relay, and/or a 5G ProSe UE-to-UE relay UE. For example, the U2U relay UE may provide data delivery service of data between a first end UE and a second end UE. The U2U relay UE may be at least a singlehop (e.g., basic) U2U relay UE and/or a multihop (e.g., evolved, advanced) U2U relay UE. The singlehop U2U UE relay may be directly connected to the first end UE and the second end UE. The multihop U2U relay UE may be connected to the first end UE via another one or more U2U relay UEs. For example, an edge U2U relay UE may be connected directly to the first end UE and/or may be connected to the second end UE via one or more UEs in the middle. For example, an interim U2U relay UE may be connected to the first end UE via one or more UEs in the middle and/or may be connected to the second end UE via one or more UEs in the middle.

In the specification, a term of sidelink may be interpreted as a direct interface between UEs. For example, the sidelink may comprise a PC5 interface. For example, a direct connection between UEs may be a sidelink connection. For example, a direct sidelink connection may be a connection between UEs without other UEs (e.g., relay UEs) in the middle. For example, an in direct sidelink connection may be a connection between UEs with one or more other UEs in the middle.

In the specification, a term of a remote UE may be interpreted as a UE which may send and/or receive traffic via one or more relay UEs, to/from the network. The remote UE may search, select and/or establish direct sidelink connection (e.g., sidelink connection, PC5 connection, D2D connection) with the relay UE. If the remote UE is out of coverage of a cell, may establish an indirect network connection to the cell via the one or more relay UEs. If a UE connects to the network via the one or more relay UEs, the UE may be interpreted as the remote UE. The remote UE and a relay UE of the one or more relay UEs may use one or more PC5 interfaces. The remote UE may receive from a network, configuration information and/or policy information for using the one or more relay UEs. The remote UE may use the configuration information and/or the policy information, when the remote UE uses the one or more relay UEs and/or when the remote UE intends to use the one or more relay UEs. For example, the remote UE may be 5G ProSe Remote UE.

In the specification, a term of an end UE may be interpreted as a UE that connects with another end UE via one or more UE-to-UE (U2U) Relays. For example, the end UE may be 5G ProSe End UE.

In the specification, a term of relay service code (RSC) may be interpreted as a code to identify a connectivity (e.g., relay) service. The RSC may be used for the case of UE-to-Network Relay as well as for the case of UE-to-UE Relay. For the case of UE-to-UE Relay, the RSC may used to identify a connectivity service that a U2U relay provides and/or authorized users that the U2U Relay may offer service to. For the case of UE-to-Network Relay, the RSC may be used to identify a connectivity service that is associated with a PDU session, and/or that is associated with a network slice, a data network and/or the like.

In the specification, a term UE-to-UE relay service (e.g., U2U relay service) may be interpreted as a data delivery service between a first UE and a second UE via one or more third UEs in the middle. For example, the first UE may send a data to the second UE via the one or more third UEs. In this case, the one or more third UEs in the middle may provide the UE-to-UE relay (or relaying) service. When the second UE receives the data, the second UE may consume (in case of U2U relaying for U2U service) the data (e.g., a second application of the second UE process the data) and/or may forward (in case of U2U relaying for U2N service) the data to other entity (e.g., the network, the relay UE).

In the specification, a term UE-to-Network relay service (e.g., U2N relay service) may be interpreted as a data delivery service between a first UE and a network via one or more third UEs in the middle. For example, the first UE may send a data to the network via the one or more third UEs. In this case, a third UE (e.g., the UE has direct (network) connection to a cell of the network, and/or the UE has a PDU session to deliver a data for the first UE) of the one or more third UEs may receive the data from the first UE via other UEs of the one or more third UEs in the middle, and/or the third UE may forward the data to the network (and/or via zero or more upstream relay UEs) via the PDU session. The data delivery service may be the UE-to-Network relay (or relaying) service, and/or a service provided by the PDU session may be the UE-to-Network relay service.

In the specification, a term multihop may be interpreted as having more than one (link, hop, interface) between a first UE and a second UE (or a network). For example, using FIG. 17 as example, for a communication between the remote C and the network, a first path (a path involving the remote C, the relay A, the relay B and the network) may be a multihop path (e.g., not singlehop), while a second path (a path involving the remote C, the relay B and the network, and not involving the relay A) may be a singlehop path (i.e., not multihop). In other example, for a communication, if more than one relay UE (or UE) are involved, it can be interpreted as multihop. In other example, for a communication, if only one relay UE (or UE) is involved, it can be interpreted as singlehop (relaying). Similarly, when two entities cannot directly communicate, if one relay (or a UE) is used in the middle of the two entities, a singlehop relaying may apply. When two entities cannot directly communicate, if more than one relays (or UEs) are used in the middle of the two entities, a multihop relaying may apply. In an example, a first indication associated with multihop relaying (e.g., multihop relay, multihop service, multihop relaying service, and/or the like) may be separate from a second indication associated with non-multihop relaying (e.g., a singlehop relaying, a legacy relaying, a relaying not using multihop, and/or the like). This may help an entity to a relevant behavior based on different indications.

In the specification, a term direct network communication may be interpreted as one mode of communication, where there is no relay UE between a UE and a network. For example, for direct network communication, the UE and the network (e.g., a basestation) may use Uu interface, and/or may not use PC5 interface. For example, in case of direct network connection (communication), the UE may be inside a coverage of the network.

In the specification, a term indirect network communication may be interpreted as one mode of communication, where there is one or more relay UEs between a UE (a remote UE) and a network. For example, for indict network communication, the UE and a first relay UE of the one or more relay UEs may use a PC5 interface and/or the network (e.g., a basestation) and a second relay UE of the one or more relay UEs may use Uu interface.

In an example, indication (e.g., indicate) may be achieved in various ways. For example, a first indication may be done via a first field in a first signalling (e.g., a message). Alternatively and/or additional, a second indication may be done by not including the first field in the first signalling. For example, if a first message comprises the first field, the first indication may be done (e.g., achieved, delivered from a sender to a receiver). For example, if the first field in the first message is set to a value A, a third indication may be done. For example, if the first message does not comprise the first field, the second indication may be done. In other example, a fourth indication may be done by sending a second signalling. Alternatively and/or additionally, a fifth indication may be done by not sending the second signalling (e.g., a message). For example, the sender can indicate something, by sending a message comprising an indicator (e.g., an information element) indicating the information. For example, when a first entity indicates to a second entity about first something, the first entity may send to the second entity, an indicator (e.g., an information element) indicating the first something, and/or may send to the second entity, a message comprising the indicator. In other example, when a first entity does not indicate to a second entity about second something, the first entity may not send to the second entity, a first indicator (e.g., an information element) indicating the second something, may not send to the second entity, a message comprising the first indicator, and/or may send to the second entity, a second indicator indicating that the second something does not apply.

In the specification, a term address may be interpreted as an identifier used for routing one or more data for an entity. For example, the address may be a unique number (or a combination of number) that identifies a device (e.g., a UE) or network that connects to the internet. For example, the address may be one or more IP addresses assigned for a PDU session, one or more IPv4 addresses, one or more IPv6 addresses, one or more interface identifiers for IPv6 link local address, one or more additional prefixes, one or more NATed IP addresses, and/or the like. For example, a topmost relay UE may use a first IP address. The topmost relay UE may allocate (e.g., assign) one or more second IP addresses to one or more downstream UEs. When the topmost relay UE receives one or more second packets (e.g., comprising the one or more second IP addresses) from the one or more downstream UEs (e.g., a first UE, a second UE, e.g., connected via a downstream relay UE), the topmost relay UE may send one or more first packets (e.g., comprising the first IP address) to a network. The one or more first packets may be similar to the one or more second packets, with the one or more second IP addresses replaced (modified, updated) to the first IP address. In this case, the one or more second IP packets may comprise at least one of a first second IP packet and/or a second second IP packet. In this case, the one or more first IP packets may comprise at least one of a first first IP packet and/or a second first IP packet. The first first IP packet may be based on a first second packet (received from the first UE via one or more downstream relay UEs, comprise one of the one or more second IP address) of the one or more second packets, may be similar to the first second packet, may comprise the first IP address, and/or may use (comprise, indicate) a first port. The second first IP packet may be based on a second second packet (received from the second UE via one or more downstream relay UEs, comprise one of the one or more second IP address) of the one or more second packets, may be similar to the second second packet, may comprise the first IP address, and/or may use (comprise, indicate) a second port. Similar process may be applicable when the topmost relay UE receives one or more first packets (from the network) and/or deliver one or more second packets (based on the one or more first packets, and replacing IP addresses) to the one or more downstream UEs. The one or more NATed IP address may comprise the first IP address and/or the one or more second IP addresses.

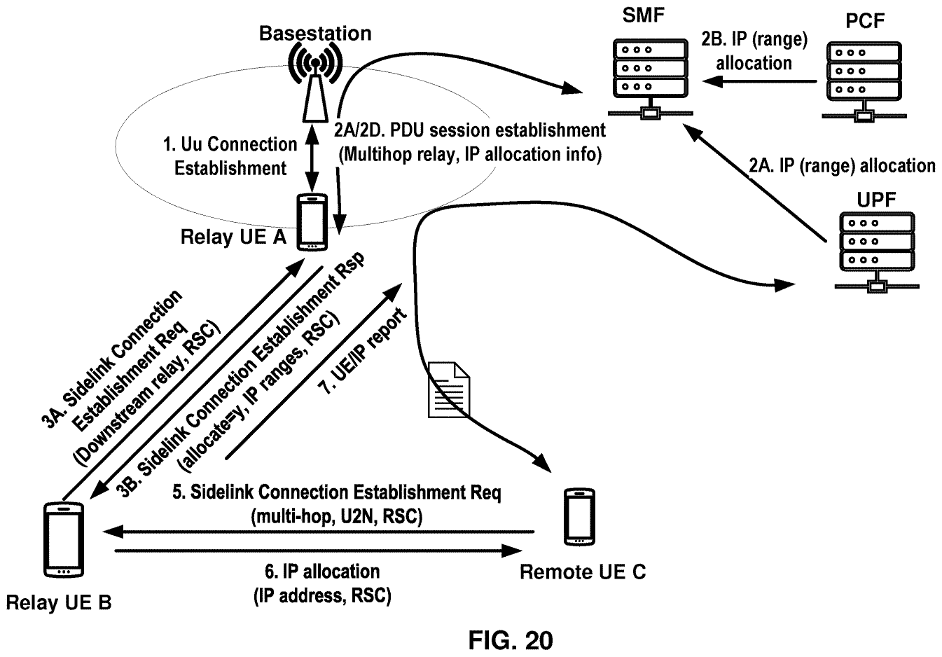

FIG. 20 depicts one example embodiment of the present disclosure. In an example, a relay UE (e.g., a relay, a relay wireless device, a wireless relay device) may serve (e.g., connected to) a UE (a downstream relay UE, a downstream remote UE) with more than one hops (e.g., link, interface) away. The relay UE may allocate one or more IP addresses to the UE. This may help one or more IP packets be communicated via one or more relay UEs. For brevity, based on the other part of the present disclosure, redundant details will be omitted.

In an example, a first UE (e.g., relay UE A, relay A, relay wireless device A, wireless relay device A) may establish a RRC connection (e.g., Uu connection) with a basestation. For example, the first UE may send a RRC Setup Request message, RRC Resume Request message, and/or the like. For example, the first UE may receive from the basestation, RRC Setup message, RRC Resume message, and/or the like. Alternative and additionally, the first UE may establish the RRC connection, when the first UE has a data to send, when another UE (e.g., a downstream UE) connected (directly, and/or indirectly) to the first UE has a data/signalling to send, and/or the like.

In an example, the first UE may establish a PDU session with a network. For example, the first UE may send a PDU session establishment request (and/or a PDU session modification request, e.g., step 2A) message for the PDU session, to a SMF. For example, the first UE may receive from the SMF, a PDU session establishment response (e.g., step 2D). For example, the PDU session may be associated a RSC that the first UE provides for relaying. For example, the first UE may establish the PDU session, before providing a relaying service for the RSC and/or after receiving a request for relaying service of the RSC. In an example, the PDU session establishment request may comprise at least one of an indication indicating that the PDU session is associated with a multihop relaying service, an indication indicating that IP PDU session is requested, an indication indicating that IP allocation is requested for multihop relaying and/or the like. In an example, the PDU session establishment response (e.g., accept) message may comprise a first IP allocation information for the PDU session. For example, the first IP allocation information comprises at least one of one or more first IP addresses and/or one or more first IP prefix, associated with the PDU session. Alternatively and/or additionally, after establishment of the PDU session, the first UE may use a DHCP procedure over user plane of the PDU session, to receive the first IP allocation information.

In an example, a second UE (e.g., a relay UE B) may be out of coverage of a cell and/or may determine to act as a downstream relay UE. For example, the second UE may not be able to find a cell to camp on (due to weak signal of the cell, or a network associated with a found cell is not allowed to the relay UE B, and/or the like). Because direct connection to the cell (the network) is not available, because the second UE is allowed (authorized) for multihop relaying (e.g., allowed to use other relay UEs to provide connectivity service to other remote UEs or to downstream UE), because a relay UE (e.g., relay UE A) in coverage is available, because the second UE receives a sidelink message indicating support for multihop relaying from the first UE, and/or because the second UE is authorized (received authorization information (e.g., the RSC 1)) for multihop relaying, because the second UE is authorized for RSC 1 associated with the multihop relaying, the second UE may determine to participate in multihop relaying, to connect to an upstream relay UE (e.g., the relay UE A), to establish a sidelink connection to another relay (e.g., relay UE A), and/or the like. Alternatively and/or additionally, the second UE may establish the sidelink connection with the first UE, when the second UE serves other downstream UEs and/or when the second UE receives a request from the other downstream UEs for multihop relaying. For example, to establish the sidelink connection, the second UE may send a sidelink message 3A to the first UE. For example, the sidelink message 3A may be a PC5 message 3A. For example, the sidelink message 3A may be at least one of Announce message, ProSe Additional Parameters Announcement Response message, ProSe PC5 Discovery message, ProSe Direct Link Establishment message, ProSe Direct Link Modification message, Sidelink connection Establishment message, and/or the like. The sidelink message 3A may comprise at least one of:
Source layer-2 ID: This may indicate source layer-2 identifier of the transmitting UE. For example, this may indicate the second UE.
Destination layer-2 ID: This may indicate target layer-2 identifier associated with one or more UEs, to which a sidelink message (e.g., the sidelink message 3A) is sent. For example, this may indicate the first UE.
RSC: This may identify a connectivity service that the transmitting UE requests. For example, this may indicate a service that the transmitting UE (e.g., the second UE) requests from a receiving UE (e.g., the first UE, an upstream relay UE), and/or may indicate that the second UE requests a multihop relaying service from the first UE. For example, this may indicate RSC 1.
Discoverer Info: This may provide information (i.e., User Info ID) about discoverer user.
Target Info: This may provide provides information (i.e., User Info ID) about targeted discovered user.
Support indicator of multihop: This may indicate that the transmitting UE (e.g., the second UE) supports multihop relaying, that the transmitting UE supports connection to another relay UE, that the transmitting UE supports multihop U2N relaying service, that the transmitting UE is authorized for multihop relaying, that the transmitting UE access as a downstream relay UE, and/or the like.
IP allocation capability for multihop: This may indicate supported IP allocation mode by the transmitting UE (e.g., the relay UE B). For example, this may indicate whether the transmitting UE supports Ipv6 Router, whether the transmitting UE supports DHCPV4 server, and/or whether the transmitting UE does not support address allocation.
Identifier of the transmitting UE (e.g., relay UE B): This may indicate an identifier of the transmitting UE. For example, this may be at least one of CP (Control Plane)-PRUK (Prose Remote User Key) ID, UP (User Plane)-PRUK ID, SUCI, and/or the like, of the transmitting UE.

In an example, the first UE may receive the sidelink message 3A. For example, based on the sidelink message 3A, the first UE may determine whether the second UE supports IP allocation for a downstream UE. For example, if the second UE indicates support of Ipv6 Router and/or DHCPV4 server. The first UE may determine that the second UE supports IP allocation for the downstream UE.

In an example, in response to receiving the sidelink message 3A, the first UE may send a sidelink message 3B to the second UE. For example, the sidelink message 3B may indicate (e.g., comprise an information indicating) at least one of that establishment of sidelink connection is successful between the first UE and the second UE, that the first UE is allowed for multihop relaying, that the second UE is allowed as a downstream relay to the first UE, that the multihop relaying service associated with the RSC 1 is allowed to the second UE, and/or the like. For example, the sidelink message 3B may comprise a first IP address configuration information and/or a second IP address configuration information. For example, the first IP address configuration information may indicate whether the first UE acts as at least one of IPv6 Router, DHCPv4 Server, an IP allocation server for a downstream UE, an IP address (e.g., of the first UE) serving as a DHCP server, and/or the like. For example, the second IP address configuration information may indicate whether the second UE is configured to act as at least one of IPv6 Router, DHCPv4 Server, an IP allocation server for a downstream UE, an IP address (e.g., of the first UE) serving as a DHCP server, and/or whether the second UE is not allowed to allocate IP address, one or more IP addresses that the second UE is allowed to allocate to the downstream UE, an UDP/TCP port range that the second UE is allowed to use (allocate) for the downstream UE, and/or one or more IP prefix that the second UE can use to allocate IP address (prefix) to the downstream UE, and/or the like. For example, the one or more IP addresses that the second UE is allowed to allocate for the downstream UE may be (associated with) one of the one or more first IP addresses and/or the one or more first IP prefix. Alternatively and/or additionally, the one or more IP addresses that the second UE is allowed to allocate for the downstream UE may be one or more IP addresses (and/or prefixes) that the first UE use for local network (e.g., among the first UE and/or one or more downstream UEs of the first UE). For example, if NAT is used, the first UE may manage a mapping between a first IP address (of the one or more first IP addresses) and/or one or more second IP addresses (that the first UE allocated to the one or more downstream UEs). In this case, the one or more IP addresses that the second UE is allowed to allocate for the downstream UE may be one or more of the one or more second IP addresses.

In an example, the second UE may send a sidelink message 4 (not shown in the Figure) to a remote UE (e.g., the remote UE C). For example, the sidelink message 4 may indicate that the second UE provides a multihop relaying service, that the second UE supports a remote UE, that the second UE provides a service associated with the RSC 1, that the multihop relaying service is provided for the RSC 1, that the second UE is connected to an upstream relay UE, and/or the like.

In an example, a third UE (e.g., the remote UE C) may receive the sidelink message 4. Because the third UE is allowed for using multihop relaying (e.g., received a message authorizing the third UE to use a multihop relaying service), and/or because a relay (e.g., second UE) providing the multihop relaying is available (e.g., based on the sidelink message 4), the third UE may select the second UE and/or may send a sidelink message 5. For example, the sidelink message 5 may indicate that the third UE requests a relaying service, that the third UE requests a multihop relaying service, that the third UE supports a capability of multihop relaying, that the third UE requests a U2N service, that the third UE requests a service associated with the RSC 1, one or more identifiers of the third UE (e.g., CP-PRUK ID, UP-PRUK-ID, SUCI) and/or the like. In an example, the second UE may receive the sidelink message 5. In response to receiving the sidelink message 5, because the second UE support a multihop relaying service for the RSC 1, because the third UE requests a multihop relaying service for the RSC 1, the second UE may determine to provide a multihop relaying service for the RSC 1. For example, because the second UE received at least one of the first IP address configuration information and/or the second IP address configuration information, because the second UE is allowed to allocate IP address to the downstream UE, because the second UE is allowed (allocated) with one or more IP address (or prefix) for the RSC 1, the second UE may determine to allocate an IP address (or prefix) to the third UE.

In an example, the second UE may send a sidelink message 6 to the third UE. For example, because the first UE allows the second UE to allocate IP address, because the second UE supports the RSC 1, because the third UE requests the RSC 1, because the second UE is allowed by the first UE to provide multihop relaying service for the RSC 1, because the second UE is assigned with one or more IP addresses by the first UE, the second UE may determine to allocate an allocated IP address of the third UE (and/or for the RSC 1) via the sidelink message 6. For example, the sidelink message 6 may comprise the allocated IP address, an indication indicating that the second UE allocates a IP address for the third UE and/or for the RSC 1, and/or the like. For example, the sidelink message 6 may be at least one of Prose Direct connection accept, Prose Direct connection modification, sidelink UE information, and/or the like.

In an example, after allocating the allocated IP address to the third UE, the second UE may send to the first UE, a sidelink report message (e.g., UE/IP report message, a sidelink information message, a sidelink report message, a PC5 Prose direct connection modification message, and/or the like, e.g., step 7). For example, the sidelink report message may comprise information of at least one of an identifier of the third UE, the allocated IP address of the third UE, an information of port (e.g., one or more UDP ports, one or more TCP ports) used by the third UE (for the allocated IP address), an RSC associated with the third UE, and/or the like.

In an example, the first UE may receive the sidelink report message. Based on the information delivered by the sidelink report message, the first UE may send a UE report to the SMF. For example, the UE report (e.g., remote UE report message, and/or the like) may indicate (e.g., comprise information of) at least one of:
an identifier of transmitting UE (e.g., the first UE).
a list of remote UE information. Each item in the list of remote UE information may indicate information of a remote UE served by the first UE and/or by one or more downstream relay UEs of the first UE. For example, each item may indicate at least one of an identifier of the remote UE, CP-PRUK ID (Control Plane ProSe Remote User Key) of the remote UE, UP-PRUK-ID (User Plane ProSe Remote User Key) of the remote UE, SUCI of the remote UE and/or the like. For example, for each remote UE in the list, one or more PDU sessions (and/or RSC) associated (e.g., used by) with the remote UE may be indicated. For example, the remote UE may be directly connected to the first UE, and/or the remote UE may be connected to one of one or more downstream relay UEs of the first UE. For example, each item in the list of remote UE information may indicate whether the remote UE is directedly connected, and/or whether the remote UE is connected via one or more downstream relay UE.
a list of relay UE information. Each item in the list of relay UE information may indicate information of a downstream relay UE served by (or connected to) the first A. For example, each item may indicate at least one of an identifier of the downstream relay UE, CP-PRUK ID (Control Plane ProSe Remote User Key) of the downstream relay UE, UP-PRUK-ID (User Plane ProSe Remote User Key) of the downstream relay UE, SUCI of the downstream relay UE and/or the like. For example, for each downstream relay UE in the list, one or more PDU sessions (and/or RSC) associated (e.g., used by) with the downstream relay UE may be indicated. For example, the downstream relay UE may be directly connected to the first UE, and/or the downstream relay UE may be connected to one of one or more other downstream relay UEs of the first A.
A list of topology information. This may comprise information the topology among the one or more remote UE and/or one or more downstream relay UEs.
amount of data. This may indicate an amount of data communicated by the each remote UE and/or the each downstream relay UE.
a type indicator. For example, for each UE indicated in the UE report, a type (e.g., a remote UE type, a relay UE type, a multihop relay UE type, a downstream relay UE type, an upstream relay UE type) of the each UE may be indicated.
List of UE/IP information. For example, for each UE indicated in the UE report, an IP address used by (or allocated to) the each UE may be indicated. For example, for each UE indicated in the UE report, a port information (e.g., one or more UDP port (range) and/or one or more TCP port (range) used by the each UE) may be indicated.

In an example, the third UE may receive the sidelink message 6. For example, based on that the second UE allocates an IP address for the third UE, the third UE may send a IP allocation request to the second UE and/or may receive the allocated IP address. Based on the allocated IP address, based on the third UE being allowed for multihop relaying, and/or based on establishing the sidelink connection with the relay UE (e.g., the second UE), the third UE may generate one or more IP packets. For example, the one or more IP packets may comprise the allocated IP address. For example, the third UE may send the one or more IP packets to the second UE. For example, the second UE may send the one or more IP packets to the first UE. For example, the first UE may send the one or more IP packets to the network. Alternatively and/or additionally, if NAT is used by one or more relay UEs (e.g., the second UE, and/or the first UE), the one or more relay UEs may update one or more IP addresses and/or ports when the one more relay UEs sends the one or more IP packets to an upstream nodes (e.g., upstream relay UEs, and/or the network). Similar behavior as applied for UL packet may be applied for DL packet.

In the example of FIG. 20, an upstream relay UE may manage (e.g., allocate) one or more IP addresses for one or more downstream UEs. This may help correct routing of IP packets when multihop relaying is used and/or generation of accurate accounting information. The behaviour described for the first UE and/or for the second UE, may be applicable also to additional downstream relay UEs (e.g., a relay UE attached to the second UE).

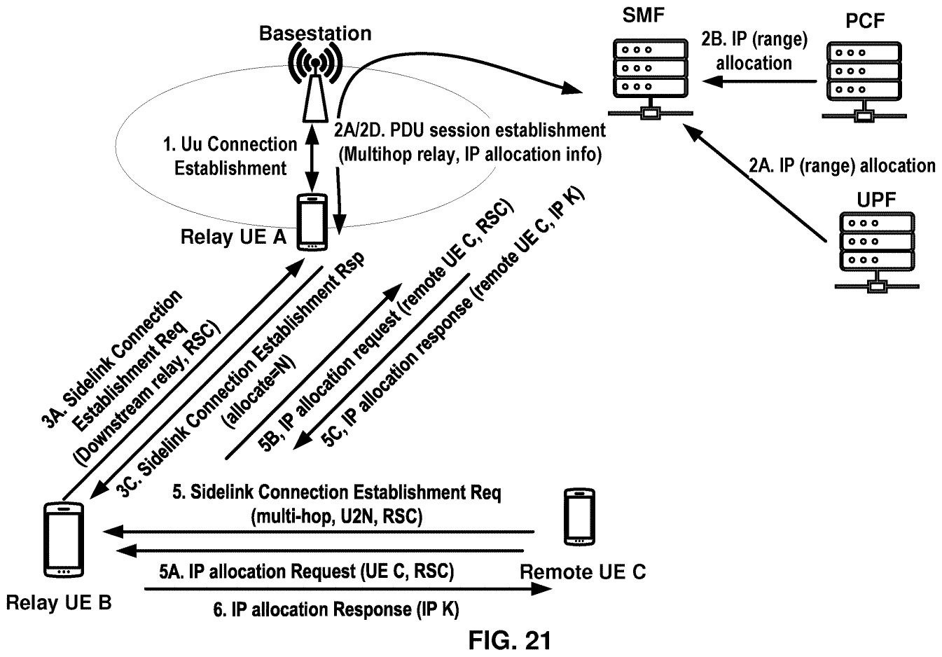

FIG. 21 depicts one example embodiment of the present disclosure. In an example, a relay UE (e.g., a relay, a relay wireless device, a wireless relay device) may serve (e.g., connected to) a UE (a downstream relay UE, a downstream remote UE) with more than one hops away. The relay UE may manage one or more IP addresses of the UE. This may help one or more IP packets are communicated via one or more relay UEs. For brevity, based on the other part of the present disclosure, redundant details will be omitted.

In an example, the first UE may establish a RRC connection (e.g., Uu connection) with the basestation. In an example, the first UE may establish the PDU session with a network.

In an example, to establish the sidelink connection, the second UE may send the sidelink message 3A to the first UE.

In an example, in response to receiving the sidelink message 3A, the first UE may send a sidelink message 3C to the second UE. For example, the sidelink message 3C may indicate (e.g., comprise an information indicating) at least one of that establishment of sidelink connection is successful between the first UE and the second UE, that the first UE is allowed for multihop relaying, that the second UE is allowed as a downstream relay to the first UE, that the multihop relaying service associated with the RSC 1 is allowed to the second UE, and/or the like. For example, the sidelink message 3C may comprise a third IP address configuration information. For example, the third IP address configuration information may indicate that the first UE acts as at least one of IPv6 Router, DHCPv4 Server, an IP allocation server for a downstream UE, an IP address (e.g., of the first UE) serving as a DHCP server, and/or the like. For example, the third IP address configuration information may indicate that the second UE is not allowed to allocate IP address to a downstream UE. For example, if the second UE does not support allocation of IP address (e.g., does not send support indication to the first UE), if the second UE does not support IPv4 server (and/or IPV6 router), and/or the like, the first UE may determine not to allow allocation of IP address by the second UE.

In an example, the second UE may send a sidelink message 4 (not shown in the Figure) to the third UE. In an example, the third UE (e.g., the remote UE C) may receive the sidelink message 4. In an example, the third UE may select the second UE and/or may send the sidelink message 5. Alternatively and/or additionally, the third UE may send a sidelink message 5A. For example, the sidelink message 5A may be a control plane message and/or a user plane message. For example, the sidelink message 5A may request allocation of IP address for the third UE and/or for the RSC 1.

In an example, the second UE may send a sidelink message 5B. For example, because the sidelink message 3C does not allow the second UE to allocate an IP address for a downstream UE, because the third UE requests a service of the RSC 1, because the second UE is a downstream relay UE of the first UE, because the first UE is a upstream relay UE of the second UE, because the first UE establishes the PDU session for the RSC 1, and/or the like, the second UE may send the sidelink message 5B. For example, the sidelink message 5B may comprise at least one of the identity of the third UE, the RSC 1, indication indicating request of IP allocation of the third UE, indication of request for a U2N service, a type of the third UE, the sidelink message 5A, one or more information element of the sidelink message 5A, and/or the like. For example, the sidelink message 5B may be one of a PC5 Prose direct connection establishment/modification message, a PC5 Prose message, a PC5 Prose assistance information, and/or the like.

In an example, the first UE may receive the sidelink message 5B from the second UE. For example, because the sidelink message 5B indicates the third UE, and/or because the sidelink message 5B requests allocation of IP for the third UE, the first UE may allocate (assign) a third IP address (and/or a third IP prefix) for the third UE. For example, the first UE may send a sidelink message 5C to the second UE. For example, the sidelink message 5C may comprise at least one of the third IP address of the third UE, the identity of the third UE, the RSC 1, a third Port information (e.g., a UDP port, a TCP port), and/or the like. For example, the third IP address may be associated with the PDU session, with multihop relaying, with the one or more first addresses, and/or with the RSC 1. For example, the sidelink message 5C may be one of a PC5 Prose direct connection establishment/modification message, a PC5 Prose message, a PC5 Prose assistance information, and/or the like.

In an example, the second UE may send the sidelink message 6 to the third UE. For example, the sidelink message 6 may comprise the third IP address. For example, the third UE may construct one or more IP packets comprising the third IP address and/or may send the one or more IP packets to the first UE via the one or more relays (e.g., the second UE).

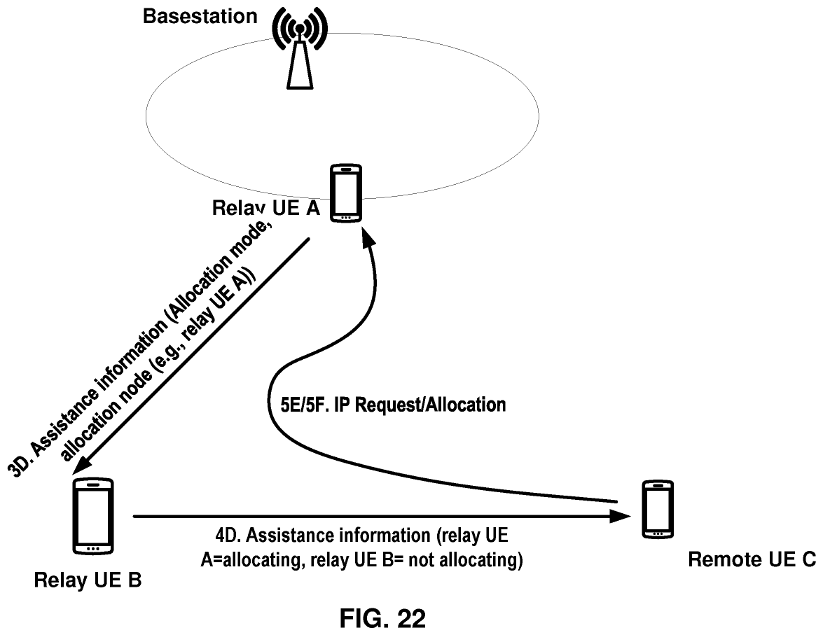

FIG. 22 depicts one example embodiment of the present disclosure. In an example, a relay UE may indicate one or more UEs allocating an IP address of a downstream UE. This may help one or more IP packets are communicated via one or more relay UEs. For brevity, based on the other part of the present disclosure, redundant details will be omitted.

In an example, the first UE may establish the RRC connection (e.g., Uu connection) with the basestation. In an example, the first UE may establish the PDU session with a network.

In an example, to establish the sidelink connection, the second UE may send the sidelink message 3A to the first UE.

In an example, in response to receiving the sidelink message 3A, the first UE may send a sidelink message 3D to the second UE. For example, the sidelink message 3D may indicate (e.g., comprise an information indicating) at least one of that establishment of sidelink connection is successful between the first UE and the second UE, that the first UE is allowed for multihop relaying, that the second UE is allowed as a downstream relay to the first UE, that the multihop relaying service associated with the RSC 1 is allowed to the second UE, and/or the like. For example, the sidelink message 3D may comprise an assistance information (e.g., IP allocation configuration information). For example, the assistance information may comprise information of IP allocating UE. For example, the information of IP allocating UE may indicate one or more allocating relay UEs allocating an IP address for one or more downstream UEs, the one or more allocating relay UEs to which a request for an IP address allocation needs to be send, one or more identifiers (e.g., Layer-2 identifier, RRC identifier, a Prose ID, a sidelink identifier, and/or the like) of the one or more allocating relay UEs, one or more addresses (e.g., an IP address) of the one or more allocating relay UEs., and/or the like. For example, the sidelink message 3D may indicate that the first UE allocates (assigns) IP address for a downstream UE (and/or for the RSC 1) and/or that the second UE does not allocates (assigns) IP address for a downstream UE (and/or for the RSC 1)

In an example, the second UE may send a sidelink message 4D to the third UE. In an example, the third UE (e.g., the remote UE C) may receive the sidelink message 4D. For example, the sidelink message 4D may indicate at least one of that the first UE allocates IP address for a downstream UE (e.g., the third UE), that the second UE does not allocate IP address for a downstream UE, one or more information (e.g., IP address, identifier) of the one or more allocating relay UE, and/or the like. For example, the sidelink message 4D may be at least one of a Prose PC5 direct connection establishment/modification message, a Prose PC5 announcement message, a Prose PC5 Discovery message, and/or the like.

In an example, the third UE may receive the sidelink message 4D. In response to receiving the sidelink message 4D, because the sidelink message 4D indicates one or more allocating relaying UE, the third UE may send a sidelink message 5E to a UE indicated by the sidelink message 4D. For example, the sidelink message 5E may comprise at least one of a request for allocation of IP address, the identifier of the first UE, the IP address of the first UE, an identifier of the third UE, an address of the third UE, a supported address version, the RSC 1 associated with a U2N service, RSC 2 associated with a U2U relaying (e.g., a connection between the third UE and the first UE), and/or the like. For example, the sidelink message 4D may be a message sent over a PC5 interface, via a PC5-S entity, via PC5-RRC entity, PC5 signalling plane, via a user plane between the first UE and the third UE, and/or the like. For example, the sidelink message 4D may be delivered via the second UE.

In an example, the first UE may receive the sidelink message 5E. In response to receiving the sidelink message 5E, because the sidelink message 5E request allocation of IP address, because the sidelink message 5E is received from a downstream UE with more than one hop away, because the sidelink message 5E is associated with the RSC 1, because the sidelink message 5E is associated with multihop relaying, the first UE may determine to allocate an IP address for the third UE connected via the second UE. For example, based on the determination of the IP address, the first UE may send a sidelink message 5F to the third UE, via the second UE. For example, the sidelink message 5F may comprise at least one of the IP address allocated to the third UE by the first UE, the RSC 1, the identifier of the third UE, and/or the like.

The example of FIG. 22 may help when the second UE is limited in capability for IP allocation.

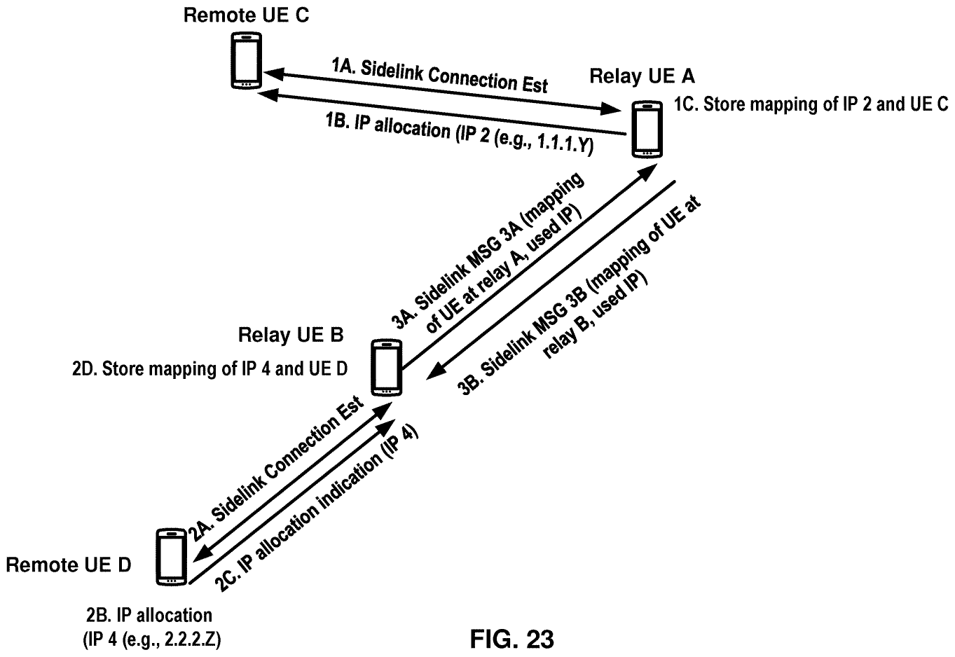

FIG. 23 depicts one example embodiment of the present disclosure. In an example, a U2U relay UE involved multihop relaying may store a mapping information between an IP address of a UE and/or an identifier of the UE. This may help one or more IP packets are communicated via one or more relay UEs. For brevity, based on the other part of the present disclosure, redundant details will be omitted.

In an example, for a communication of IP packets among one or more UEs, a plurality of UEs may be involved to extend communication range. In this case, if an IP address domain of a first entity of the one or more UEs is different than an IP address domain of a second entity of the one or more UEs, a similar problem as depicted in FIG. 19 may occur.

In an example, one or more remote UEs (e.g., end UEs, remote UE C, remote UE D) may establish an end-to-end U2U relaying connection via one or more U2U multihop relay UEs (e.g., relay B, relay A) for RSC 2 (e.g., a RSC for U2U relaying).

For example, the remote UE C may send a sidelink message 1A (e.g., a Prose PC5 direct connection establishment request message) to a relay A (e.g., relay UE A). For example, the relay A may support multihop U2U relaying. For example, in response to receiving the sidelink message 1A, the relay A may send a sidelink message 1B to the remote UE C. For example, the sidelink message 1B may comprise an allocated IP address (e.g., IP 2 (e.g., 1.1.1.Y), second IP address) of the remote UE C, an identifier of the remote UE C, and/or the RSC 1. For example, the relay A may store a second mapping information of the IP 2 and/or the remote UE C. For example, the second mapping information may comprise at least one of the second IP address (e.g., IP 2) of the remote UE C, the RSC 1, an entity (e.g., the relay UE A) assigned the second IP address, a relay (e.g., the relay A) connected to the remote UE C, and/or an identifier of the remote UE C.

For example, the remote UE D may send a sidelink message 2A (e.g., a Prose PC5 direct connection establishment request message) to a relay B (e.g., relay UE B). For example, the relay B may support multihop U2U relaying. For example, in response to receiving the sidelink message 2A, the relay B may send a sidelink message 2B to the remote UE D. For example, the sidelink message 2B may indicate successful establishment of sidelink connection between the remote UE D and the relay B, for a U2U relaying connection, and/or for the RSC 2. In response to receiving the sidelink message 2B, because the remote UE D establishes a U2U relaying connection to the relay B (and/or relay A, remote UE C), the remote UE D may determine to assign a fourth IP address (e.g., IP 4 (e.g.,2.2.2.z)) to the remote UE D. For example, to indicate the fourth IP address of the remote UE D, the remote UE may send a sidelink message 2C to the relay B. For example, the sidelink message 2C may comprise the fourth IP address of the remote UE D, the RSC 2, and/or an identifier of the remote UE D. For example, the relay B may store a fourth mapping information of the IP 4 and/or the remote UE D. For example, the fourth mapping information may comprise at least one of the fourth IP address (e.g., IP 4) of the remote UE D, the RSC 2 and/or the identifier of the remote UE D.

In an example, the relay B may discover the relay A, the relay B receives a sidelink announcement message from the relay A, and/or may the relay B may determine to establish a multihop connection with the relay A. For example, the relay B may send a sidelink message 3A to the relay A, to establish a U2U relaying connection for the remote UE D. For example, the sidelink message 3A may be at least one of a PC5 message 3A, a sidelink connection request message 3A, a 5G Prose direct link establishment (e.g., a PC5 Prose direct connection establishment) message, a PC5 Prose message, a sidelink assistance information, a side UE information, Prose Parameter announcement message, Prose UE-to-UE relay update request, and/or the like. For example, the sidelink message 3A may comprise the fourth mapping information, a third mapping information, a second topology information, and/or the like. For example, the third mapping information may comprise at least one of an IP address of the relay B, an identifier of the relay B, and/or the like. For example, the second topology information may indicate that the remote UE D is connected to the relay B. For example, the sidelink message 3A may comprise one or more identifier of one or more downstream UEs of the relay B, one or more IP addresses used by each of the one or more downstream UEs, mapping information of the one or more identifier of the one or more IP addresses, and/or the like. For example, the relay A may send a sidelink message 3B to the relay B. For example, the sidelink message 3B may comprise the second mapping information, a first mapping information, a first topology information, and/or the like. For example, the first mapping information may comprise at least one of an IP address of the relay A, an identifier of the relay A, and/or the like. For example, the first topology information may indicate that the remote UE C is connected to the relay A. For example, the sidelink message 3B may comprise one or more identifier of one or more downstream UEs of the relay A, one or more IP addresses used by each of the one or more downstream UEs, mapping information of the one or more identifier of the one or more IP addresses, and/or the like. For example, a topology information (e.g., the first topology information and/or the second topology information) may help a UE in the middle (e.g., the relay A, the relay B) to determine to which entity a packet needs to be delivered, in case of U2U relaying. For example, if the relay A receive a IP packet A (with target IP address is IP 4) from a UE K, because the second mapping information (and/or the second topology information) indicates that the IP 4 is used by the remote UE D and/or that the remote UE D is a downstream UE of the relay B, the relay A may forward the IP packet A to the relay B. This may help IP routing when one or more IP address used among the UEs are allocated by different entities (e.g., relays, remote UEs, end UEs) and/or uses multiple IP domains.

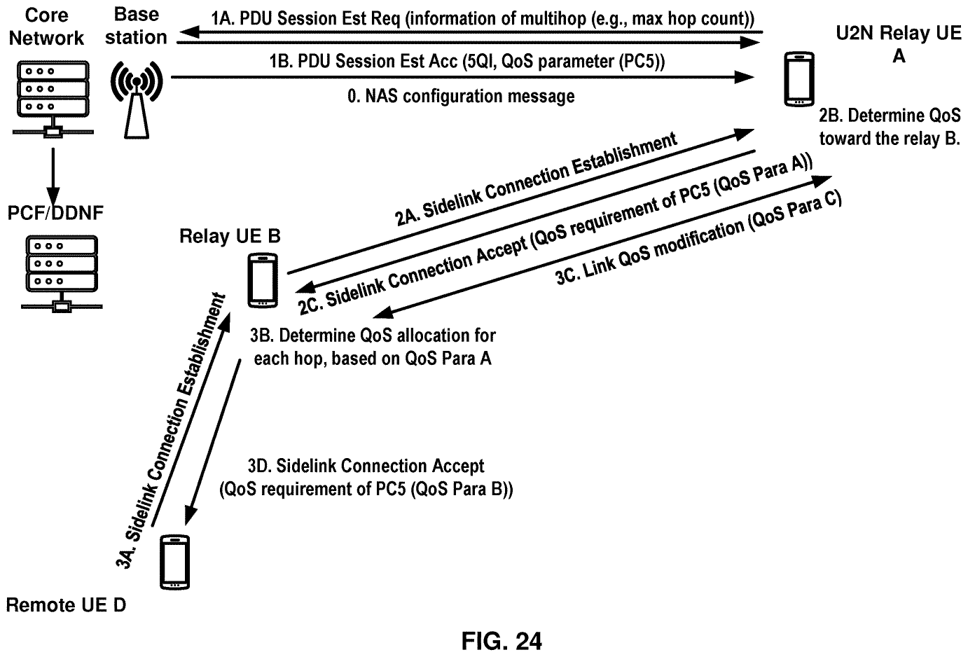

FIG. 24 depicts one example embodiment of the present disclosure. In an example, when a relay UE allocates an IP address for a downstream UE, the relay UE may consider QoS provided for the downstream UE. For example, depending on whether a QoS requirement can be supported for the downstream UE, the relay UE may determine whether to allocate the IP address or not. This may help efficient allocation of the IP address. For brevity, based on the other part of the present disclosure, redundant details will be omitted.

In an example, a network entity (e.g., a PCF, a SMF, an AMF) may send a NAS configuration message (e.g., step 0) to a first UE (e.g., a U2N relay A, a U2N relay UE A, a relay UE A, a multihop relay UE A, and/or the like). For example, based on that the first UE supports multihop relaying (e.g., by receiving from the first UE, a capability indication of multihop relaying), the network entity may send the NAS configuration message. For example, the NAS configuration message may be at least one of registration accept, UE configuration update, DL NAS transfer, and/or the like. For example, the NAS configuration message may comprise configuration parameters for multihop relaying (e.g., a first configuration parameter for multihop). For example, the configuration parameters for multihop relaying may comprise at least one of
a validity time for the configuration parameters for multihop relaying. For example, this may indicate a time when the configuration parameters for multihop relaying is valid. For example, when the validity time is over, the first UE may discard the configuration parameters for multihop relaying.
one or more relay service code (RSCs) for multihop relaying. For example, for each RSC of the one or more relay service codes, a maximum number of hops, a set of PDU session parameters and/or a QoS mapping rule may be indicated. For example, the set of PDU session parameters may comprise at least one of a DNN, a SSC mode, S-NSSAI, and/or the like. For example, the QoS mapping rule may indicate at least one of a mapping between a 5QI and a 5G Prose PQI (e.g., a singlehop PQI) and/or a mapping between a 5QI and a multihop 5G Prose PQI (e.g., multihop PQI), and/or the like. For example, the singlehop PQI may be used when the first UE serves as a singlehop relay UE and/or the multihop PQI may be used when the first UE serves as a multihop relay UE.

In an example, the first UE may send (e.g., step 1A) a first NAS message (e.g., NAS message 1, PDU session establishment request message 1, and/or the like). For example, the first NAS message may comprise one or more parameter (e.g., network slice identifier, one or more traffic descriptor, a data network name, and/or the like) for a PDU session. For example, the PDU session may be used to transport a data between a network (e.g., an application server, a data network) and/or the one or more downstream UEs of the first UE, and/or the PDU session may be associated with a RSC 1 (for a multihop relaying, for a multihop U2N relaying service). For example, the first NAS message may comprise information of multihop. For example, the information of multihop may indicate a first number of maximum hops used (established) for the first UE. For example, if the first UE has a sidelink connection with a relay B (e.g., a relay UE B) and/or if the relay B does not have a downstream UE, the first number may be 1 (e.g., not including Uu interface) and/or 2 (e.g., including the Uu interface). For example, if the first UE has a sidelink connection with a relay B (e.g., a relay UE B) and/or if the relay B has a downstream UE (without any further downstream UE of the downstream UE), the first number may be 2 (e.g., not including Uu interface) and/or 3 (e.g., including the Uu interface). For example, this may help the SMF (and/or PCF via the SMF) to determine QoS information (e.g., QoS parameter, QoS rule, QoS profile) for the multihop relaying. For example, when the information of multihop indicates increase in the number of maximum hops, the SMF may determine to update the QoS information. For example, the SMF may reduce an allowed maximum delay from a UPF to the first UE and/or the SMF may allow increased (and/or decreased) maximum delay from the first UE to the downstream UE, may reduce allowed bit rate for the first UE and/or for one or more downstream UEs of the first UE.

In an example, the SMF may receive the first NAS message. For example, the SMF may send a second NAS message (e.g., NAS message 2, PDU session establishment accept message 2, UE configuration update, and/or the like). For example, the second NAS message may comprise a second configuration parameters for multihop relaying. For example, the second configuration parameters for multihop relaying may be similar to the configuration parameters for multihop relaying. For example, the second configuration parameters for multihop relaying may be updated based on information delivered by the first NAS message. Alternatively and/or additionally, the first UE may send to the AMF (and/or the PCF) the information of multihop and/or may receive from the AMF (and/or the PCF) the second configuration parameter for multihop relaying.

For example, the second NAS message (and/or the NAS configuration message) may indicate a first QoS information (e.g., a first QoS rule, a first URSP, a first prose policy) for the multihop relaying. For example, the first QoS information may comprise one or more QoS flow information for Uu (e.g., Uu QoS information, Uu QoS information for multihop). For example, each of the one or more QoS flow information for Uu may comprise at least one of a QFI for a QoS flow, one or more packet filters (e.g., indicating which traffic is mapped to the QoS flow, traffic description, traffic descriptor) for the QoS flow, a QoS parameter (e.g., 5QI, flow bit rate, packet loss rate, packet delay budget) for the QoS flow, and/or the like. For example, the first QoS information may comprise one or more QoS information for PC5 (e.g., PC5 QoS information, PC5 QoS information for multihop, PC5 multihop QoS information, Sidelink QoS information, Multihop QoS information). For example, the one or more QoS information for PC5 may comprise (e.g., indicate information of) at least one information for multihop QoS (e.g., a PER, a PDB, a PQI (e.g., PC5 QoS Indicator, PC5 QoS Flow Identifier, a RSC (e.g., the RSC 1), the multihop PQI, and/or the like) and/or information for singlehop QoS (e.g., a PER, a PDB, a PQI (e.g., PC5 QoS Indicator, PC5 QoS Flow Identifier, the single hop PQI and/or the like). For example, the Uu QoS information (e.g., the one or more QoS flow information for Uu) may be applicable for the PDU session, from the first UE to the network, and/or for Uu interface. For example, the PC5 QoS information (e.g., one or more QoS information for PC5 for multihop relaying, multihop PQI, and/or the like) may be applicable for one or more sidelink connections, one or more PC5 interfaces, from the first UE to one or more downstream UEs of the first UE, a multihop relaying and/or the like.

In an example, the first UE may receive the second NAS message. Alternatively and/or additionally, one or more information of the second NAS message may be delivered to the basestation. For example, the basestation may use the one or more information to configure the first UE and/or the one or more downstream UEs.

In an example, the first UE may establish a sidelink connection with a relay UE B. For example, the relay UE B may send to the first UE, a sidelink connection establishment (e.g., 5G Prose direct link establishment request) message (e.g., step 2A). In response to receiving the sidelink connection establish message, the first UE may determine a sidelink configuration for the relay UE B and/or for a link between the first UE and the relay UE B. For example, based on a configuration parameter for multihop relaying (e.g., the first configuration parameters for multihop (relaying), the second configuration parameter for multihop (relaying), and/or the like) and/or the first QoS information, the first UE may determine a first configuration (e.g., sidelink resource configuration, sidelink RRC/RLC/MAC parameters, PC5 QoS flow configuration, QoS parameter A, and/or the like, e.g., end-to-end sidelink). For example, the first UE may send to the relay UE B, a sidelink message 2C (e.g., sidelink connection accept message). For example, the sidelink message 2C may comprise information of the first configuration. For example, the first configuration may comprise information for a connection between the first UE and a downstream UE via the relay UE B. For example, the first configuration may comprise the PC5 QoS information for a connection (e.g., paths, hops) from a downstream UE (of the relay UE B) to the first UE, for multihop relaying and/or for the RSC 1. In other example, if the first UE does not allow the relay UE B for multihop relaying, the first configuration may not comprise PC5 configuration for multihop and/or may comprise PC5 configuration for singlehop.

In an example, the relay UE B may act (perform) as a downstream relay of the first UE. In an example, a remote UE (e.g., a remote UE D) may establish a connection (e.g., a sidelink connection) with the relay UE B for a multihop relaying service (e.g., via the PDU session, via the RSC 1). For example, the remote UE may send a sidelink message 3A. For example, the sidelink message 3A may request a relaying service for the PDU session, for the RSC 1, and/or for multihop relaying service for the RSC 1.

In an example, in response to receiving the sidelink message 3A, the relay UE B may determine a second configuration (e.g., QoS parameter B) and/or a third configuration (e.g., QoS parameter C). For example, the second configuration (e.g., for one or more links between the relay UE B and a downstream UE (e.g., remote UE D)) may comprise at least one of a second radio parameters (e.g., sidelink RRC/RLC/MAC parameters, sidelink resource configuration,), a second bearer parameters (PC5 QoS flow configuration, QoS parameter B), and/or the like, of a second link. For example, the second link may be a link (e.g., hop) between a downstream UE (e.g., the remote UE D) and/or the relay UE B. For example, the third configuration (e.g., for one or more links between the relay UE B and a upstream UE (e.g., the first UE) may comprise at least one of a third radio parameters (e.g., sidelink RRC/RLC/MAC parameters, sidelink resource configuration,), a third bearer parameters (PC5 QoS flow configuration, QoS parameter B), and/or the like, of a third link. For example, the third link may be a link (e.g., hop) between an upstream relay UE (e.g., the first UE) and/or the relay UE B. For example, the relay UE B may determine the second configuration and/or the third configuration, based on the first configuration, radio link measurement (e.g., of the second link, of the third link), a number of hops, and/or the like. For example, the first configuration may indicate a first PDB (e.g., 100 ms), a first PER, a first PQI (e.g., PQI 1), and/or the like. For example, the relay UE B may select the second configuration and/or the third configuration which meet the requirement of the first configuration. For example, the relay UE B may determine a second PDB (e.g., 40 ms), a second PER, a second PQI (e.g., PQI 6), for the second configuration. For example, the relay UE B may determine a third PDB (e.g., 60 ms), a third PER, a third PQI (e.g., PQI 10), for the third configuration. For example, based on the first configuration, the relay UE B may determine the second configuration and/or the third configuration that can meet requirements of the first configuration.

In an example, based on the determination of the second configuration and/or the third configuration, the relay UE B may configure (e.g., update, modify, e.g., send PC5 direct link modification/update request) the second link and/or the third link. For example, based on the second configuration, the relay UE B may send a sidelink message 3D to the remote UE D. For example, based on the second configuration, the sidelink message 3D may comprise a second parameter (e.g., RRC parameter, RLC parameter, NAS parameter, e.g., the second configuration) for the second link. For example, based on the third configuration, the relay UE B may send a sidelink message 3C to the first UE. For example, based on the third configuration, the sidelink message 3D may comprise a third parameter (e.g., RRC parameter, RLC parameter, NAS parameter, the third configuration) for the third link. For example, a parameter (e.g., the first parameter, the second parameter, the third parameter) may indicate a priority of one or more data flow (e.g., PQI, QFI), a timer (e.g., retransmission, expiry) value for RLC/RRC/MAC, and/or the like. For example, if a QoS requirement indicated by one or more parameters (e.g., the first configuration, the first QoS information, and/or the like) cannot be met over the one or more sidelink connections (e.g., from the remote UE D to the first UE, e.g., from the downstream UE (e.g., the remote UE D) to the top edge relay UE (e.g., the first UE)), the relay UE B may determine to release the sidelink connection of the remote UE D (e.g., from the remote UE D to the relay UE B (and/or the first UE)) and/or may determine to stop (e.g., release, reject) providing multihop relaying services to one or more downstream UEs. For example, the relay UE B may send a direct link release message to the remote UE D. Additionally and/or alternatively, the relay UE B may report to the first UE that the QoS requirement cannot be met for a downstream UE (e.g., the remote UE D) and/or the first UE may release a connection between the downstream UE and the first UE (and/or the relay UE B).

In an example, the relay UE B may determine whether the second parameter is supported by the remote UE D and/or whether the second parameter supports a QoS requirement of an application (e.g., PC5 QoS flow) of the remote UE D. For example, the relay UE B may receive the QoS requirement from the remote UE D, during establishment of sidelink connection. For example, if the second parameter (e.g., PC5 QoS Flow identifier, PQI 5, e.g., processing time less than 1ms) is not supported by the remote UE D, if radio condition does not support, and/or if the second parameter does not support a QoS requirement (e.g., the application requests 1 Mbps, the second parameter supports up to 0.5 Mbps) of the application of the remote UE D, the relay UE B (and/or the first UE) may determine not to allocate an IP address to the remote UE D and/or may release the sidelink connection. For example, in this case, the IP address may not be allocated to the remote UE D in the examples (e.g., as shown in the FIGS. 20, 21, 22, 23, 24).

In an example, alternatively and/or additionally, the first UE may send to the relay UE B (similarly from the relay UE B to a downstream UE), a value for scaling (e.g., scaling factor for multihop). For example, a core network node (e.g., a PCF, a AMF, a SMF) may send the value to the first UE. For example, the value for scaling may indicate how the relay UE B distribute the first configuration (e.g., sidelink end-to-end (e.g., from topmost relay UE to a downstream UE) PDB) to the second configuration (e.g., PDB for a downstream link (e.g., the second link between the relay UE B and the remote UE D)) and/or the third configuration (e.g., PDB for a upstream link (e.g., the third link between the relay UE B and the first UE)). For example, the value may indicate a ratio. For example, if the ratio is 60% and an end-to-end PDB is 100 ms, 60 ms may be allocated for the third link and/or 40 ms may be allocated for the second link. For example, the value may indicate a scaling factor. For example, if the scaling factor is 20% and a configured PQI for the second link indicates 50 ms for PDB, 40 ms may be applied as a PDB for the second link. The value may be applied by the first UE, the relay UE B, the remote UE D. The value may be communicated to the first UE, relay UE B and/or the remote UE D.

The example of FIG. 24 may help to correctly configure radio parameters, by informing the relay B know QoS setting of downstream UEs.

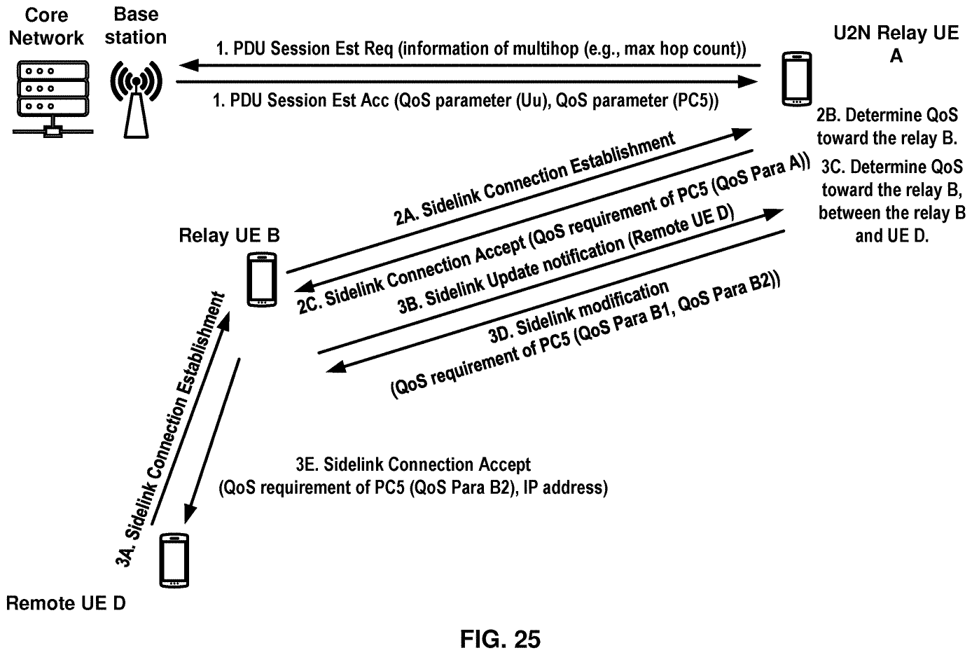

FIG. 25 depicts one example embodiment of the present disclosure. In an example, an upstream relay UE may change a configuration with a downstream relay UE, when a remote UE establishes a connection with the downstream relay UE. This may help efficient use of radio resources (e.g., IP address). For brevity, based on the other part of the present disclosure, redundant details will be omitted.

In an example, the first UE may receive the NAS configuration message and/or the second NAS message. In an example, the first UE may establish the sidelink connection (e.g., direct link connection, PC5 interface connection, and/or the like) with the relay UE B. For example, the first UE may send to the relay UE B, a sidelink message 2C (e.g., sidelink connection accept message, PC5 Prose direct link establishment accept). For example, the sidelink message 2C may comprise information a fourth configuration. For example, the fourth configuration may comprise information for the sidelink connection between the first UE and the relay UE B. For example, the fourth configuration may comprise a PC5 QoS information for a link (e.g., path, hop, the third link) from the relay UE B to the first UE, for the RSC 1. For example, the fourth configuration may not consider additional (subsequent, downstream) link from the relay UE B (e.g., to a downstream UE of the relay UE B, e.g., remote UE D). For example, based on that the relay UE B does not indicate one or more downstream UEs of the relay UE B, and/or for the RSC 1, the first UE may consider (determine) to use (apply) the fourth configuration and/or may determine to apple a configuration of singlehop relaying and/or may determine to use the 5G Prose PQI (e.g., the singlehop PQI), and/or the like. For example, the fourth configuration may comprise similar information as (and/or based on) the 5G ProSe PQI. For example, for a traffic associated with the RSC 1, the relay UE B and/or the first UE may send the traffic, with the fourth configuration and/or based on parameter using the fourth configuration. For example, the fourth configuration may use similar structure as the first configuration, the second configuration, and/or the third configuration.

In an example, a downstream UE (e.g., the remote UE D) may establish a sidelink connection (e.g., e.g., for the second link) with the relay UE B for the multihop relaying service (e.g., via the PDU session, via the RSC 1). In an example, the relay UE B may receive the sidelink message 3A and/or may send a sidelink message 3B to the first UE. For example, the sidelink message 3B may indicate at least one of that the remote UE D requests a multihop relaying service, that a number of hops is increased, that the remote UE D is associated with the RSC 1, that the remote UE D is a downstream UE of the relay UE B, an information on supported QoS (e.g., delay, bitrate) over the second link, information of PQI requested by the remote UE D, information of supported QoS (e.g., one or more PQIs supported over the sidelink interface between the remote UE D and the relay B) and/or the like.

In an example, in response to receiving the sidelink message 3B, the first UE may determine whether to establish (or release, reject) a connection with the remote UE D, whether to provide a multihop relaying service for the remote UE D, and/or whether to update a configuration for the multihop relaying. For example, because the sidelink connection between the first UE and the relay UE B is used for multihop relaying, because the number of hops behind the relay UE B increases, because a downstream UE is added to the relay UE B, and/or the like, the first UE may determine to update the configuration. For example, the first UE may determine to apply a multihop configuration (e.g., the multihop PQI (e.g., between the first UE and the relay UE B, between the first UE and the remote UE D, between the remote UE D and the relay UE B, and/or the like)) for one or more downstream UEs (e.g., the relay UE B, the remote UE D). For example, based on the multihop configuration, and/or based on the first configuration, the first UE may determine the third configuration for the third link and/or the second configuration for the second link.

In an example, the first UE may send a sidelink message 3D to the relay UE B. For example, the sidelink message 3D may comprise the third configuration and/or the second configuration. For example, the relay UE B may send a sidelink message 3E. For example, the sidelink message 3E may indicate successful establishment of a sidelink connection, provision of multihop relaying service, the second configuration, one or more parameters based on the second configuration, and/or the like.

In an example, based on the number of hops and/or based on the sidelink message 3B, the first UE may be able to determine a number (number X) of hops required to support the remote UE D. The first UE may be able to determine a maximum number (number Y) of hops that are allowed for the RSC 1. If the number Y is smaller than (or equal to) the number X, the first UE may determine not to provide the multihop relaying service for the remote UE D, and/or may send direct link connection release (reject) message to the remote UE D and/or to (via) the relay UE B. Similar determination may be performed by the basestation and/or the relay UE B. For example, when the remote UE D sends a RRC connection request message to the basestation (via the first UE, and/or the relay UE B), the first UE (and/or the relay UE B) may report a number of hops, to the basestation. For example, based on the maximum number of hops allowed for the RSC, for the first UE, for the relay UE B, and/or for the remote UE D, and/or based on the hops required up to the remote UE D, the basestation may send a RRC connection reject (and/or sidelink connection reject) message to the first UE, the relay UE B, and/or the remote UE D. For example, if the allowed number of hops is 2, the basestation may determine to reject the RRC connection request from the remote UE D.

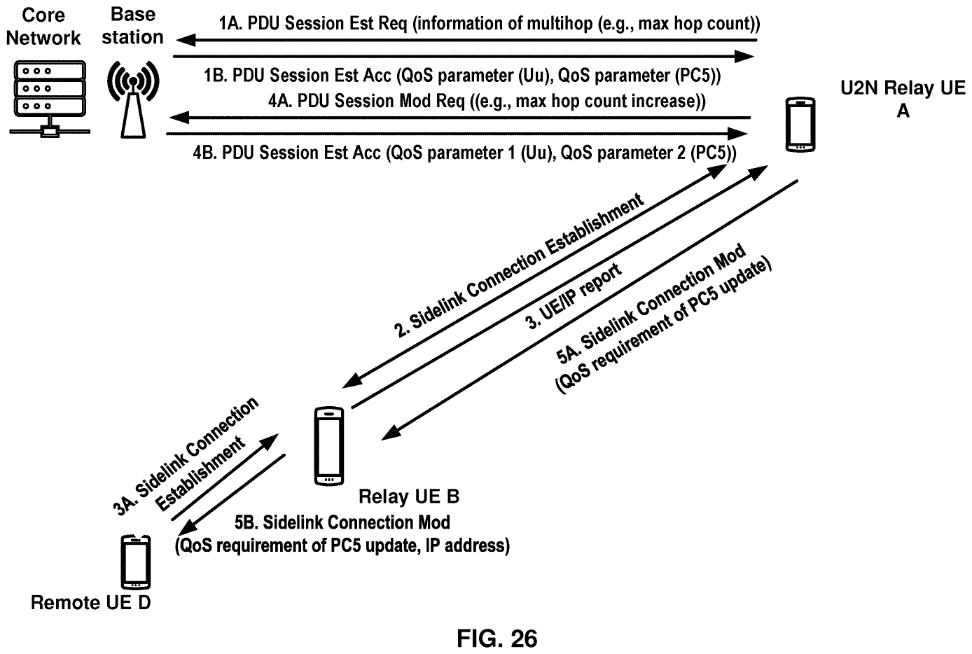

FIG. 26 depicts one example embodiment of the present disclosure. In an example, an upstream relay UE may send a notification to a core network when a number of hops changes for multihop operation. This may help efficient use of radio resources (e.g., IP address). For brevity, based on the other part of the present disclosure, redundant details will be omitted.

In an example, the relay UE A (and/or relay UE B) may receive a connection request from the remote UE D. In an example, the relay UE B may send to the first UE, information of the remote UE D. For example, the information of the remote UE D may comprise at least an identifier of the remote UE D, a RSC for multihop relaying requested by the remote UE D, a number of hops between the remote UE D and the relay UE B (and/or the first UE) and/or the like.

In an example, the first UE may send a NAS message 4A to a network node (e.g., SMF, AMF, PCF). For example, the NAS message 4A may comprise one or more information, based on the information of the remote UE D. For example, the NAS message 4A may indicate a maximum number of hops (e.g., between the first UE to a downstream remote UE) used for the PDU session, an increase (decrease) of the maximum number of hops, and/or the RSC 1. In an example, based on change of the maximum number of hops, the network node may send a second NAS configuration message and/or a NAS message 4B, to the first UE. For example, the second NAS configuration message may use a similar format and/or comprise similar contents as the NAS configuration message, with update, based on the NAS message 4A. For example, the NAS message 4B may use a similar format and/or comprise similar contents as the NAS message 2, with update, based on the NAS message 4A. For example, one or more QoS parameters may be updated. For example, if the maximum number of hops is increased, a PDB for Uu interface may be reduced and/or a PDB for multihop PC5 interfaces may be increased. In an example, the first UE may receive the NAS message 4B. Based on the NAS message 4B, the first UE may update/establish sidelink connections with one or more downstream UEs. In an example, if the basestation configures one or more RRC parameters for one or more UEs, the network node may send the similar information as the NAS message 4B to the basestation. In this case, the basestation determine one or more configurations (e.g., the first configuration, the second configuration, and/or the third configuration), and may send the one or more configuration to one or more UEs (e.g., the first UE, the relay UE B, the remote UE D).

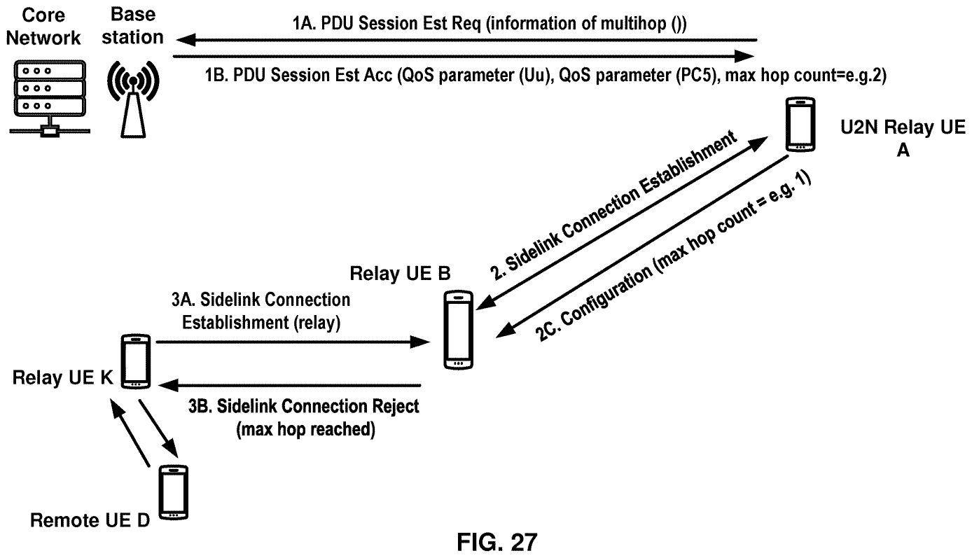

FIG. 27 depicts one example embodiment of the present disclosure. In an example, a relay UE may receive information of a number of allowed hops (e.g., a maximum number of hops allowed for the UE to use when using multihop relaying). This may help efficient allocation of the IP address (e.g., prevent unnecessary allocation of IP resources). For brevity, based on the other part of the present disclosure, redundant details will be omitted.

In an example, the first UE may receive the NAS message 2 (and/or the NAS configuration message). For example, the NAS message 2 may indicate a first number (e.g., 2) for the maximum allowed hops for the RSC 1 (and/or for the PDU session).

In an example, the first UE may establish the sidelink connection with the relay UE B. For example, the first UE may send to the relay UE B, the sidelink message 2C. For example, the sidelink message 2C may indicate at least one of that, the relay UE B is allowed for multihop relaying operation, that the relay UE B is connected as a downstream relay of the first UE for the RSC 1, a second number (e.g., 1) for an allowed maximum number of hops. For example, the second number may indicate a maximum number of hops over which the relay UE B can establish a connection with a downstream UE. For example, because the second number is 1, the relay UE B can serve a remote UE 1 which the relay UE B can have a direct connection (e.g., without a relaying UE in the middle). For example, because the second number is 1, the relay UE B cannot serve a remote UE 2 (e.g., the remote UE D), for which the relay UE B needs to use another relay UE to connect to the remote UE 2. For example, when the relay UE B receives a first connection request (e.g., requesting to serve as a downstream relay UE) from a downstream relay UE (e.g., the relay K) and/or from a remote UE (e.g., the remote UE D via the relay K), based on the number of hops to the remote UE, and/or based on the second number, the relay UE B may send a Prose direct link connection reject (and/or release) message to the relay K and/or to the remote UE D. For example, the prose direct link connection reject message may comprise a cause value indicating that maximum number of hops are reached, that multihop is not allowed, and/or the like. Alternatively and/or additionally, the relay UE B may receive the second number from a network node (e.g., via multihop prose policy information) for the RSC 1. Alternatively and/or additionally, the relay UE B may forward the connection request from the remote UE D to an upstream relay UE (e.g., the first UE), and/or the upstream relay UE may determine whether to accept the connection request from the UE or not. Alternatively and/or additionally, the remote UE D may send the RRC connection request to the basestation via one or more upstream relay UEs. The basestation may receive from a core network, one or more configuration (e.g., maximum number of allowed hops) for one or more UEs (e.g., the remote UE D, and/or one or more upstream relay UEs of the remote UE D). Based on the one or more configurations, the basestation may determine whether allowing RRC connection to the remote UE D may result in more hops (than the maximum number of allowed hops) being used at least one of the one or more UEs. In this case, the basestation may reject the RRC connection request from the remote UE D. In other case, the basestation may accept the RRC connection request from the remote UE D.

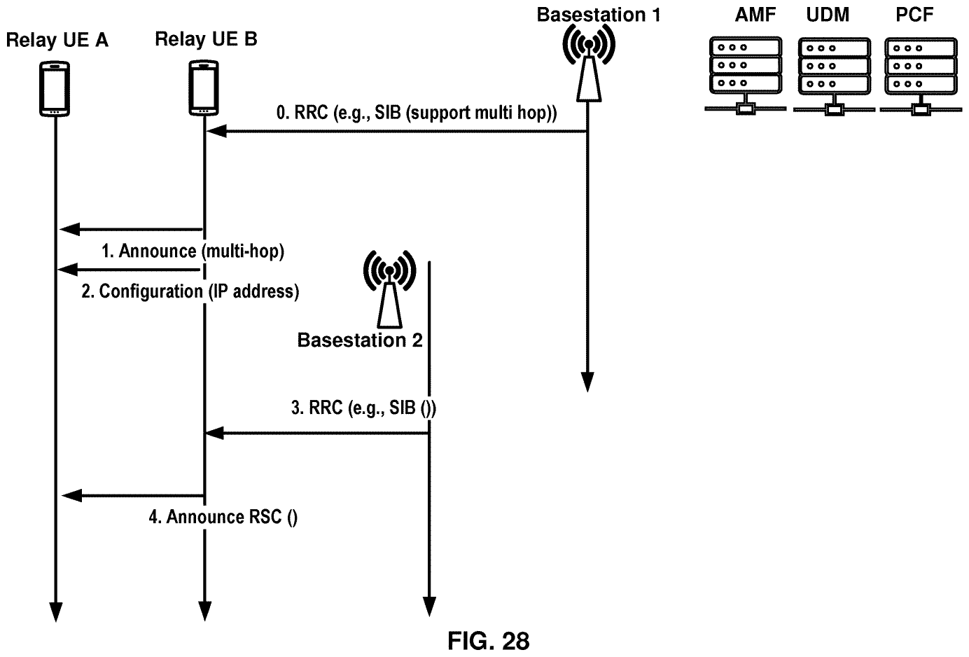

FIG. 28 depicts one example embodiment of the present disclosure.

In an example, a first basestation may be an advanced basestation supporting multihop relaying operation and/or may be connected to a network supporting the multihop relaying operation. In an example, a second basestation may be a legacy basestation not supporting multihop relaying operation and/or may be connected to a network not supporting the multihop relaying operation.

In an example, because the first basestation supports the multihop operation, the first basestation may send a RRC message 0 (e.g., a SIB 0, a RRC configuration message, and/or the like) to a relay UE B. For example, the RRC message 0 may indicate support of the multihop operation and/or may indicate that multihop operation is allowed.

In an example, if the relay UE B is authorized for multihop relaying (e.g., the relay UE B received an authorization from a network for multihop relaying), because the first basestation indicates support of the multihop relaying, the relay UE B may send to a downstream UE (e.g., the relay UE A), a sidelink message 2 (e.g., a sidelink announcement message, a direct link connection message) indicating support of multihop relaying. The relay UE B may receive from the relay UE A, a sidelink connection request and/or may send to the relay UE A, a first IP address for multihop operation.

In an example, because the second basestation does not support the multihop operation, the first basestation may send a RRC message 3 (e.g., a SIB 3, a RRC configuration message, and/or the like) to a relay UE B. For example, the RRC message 3 may not indicate support of the multihop operation and/or may indicate that multihop operation is not supported.

In an example, when a first signal quality of the first basestation gets weaker (e.g., 3 dBm lower) than a first signal quality of the second basestation, the relay UE B may camps on a cell of the second basestation. When the relay UE B is authorized for multihop relaying, because the second basestation does not indicate support of the multihop relaying, the relay UE B may send to a downstream UE (e.g., the relay UE A), a sidelink message 4 (e.g., a sidelink announcement message, a direct link connection message) not indicating support of multihop relaying. The relay UE B may not receive from the relay UE A, a sidelink connection request for multihop relaying and/or may send a sidelink connection message releasing the sidelink connection between the relay UE B and/or the relay UE A (and/or stopping relaying operation of the relay UE A).

In an example, a relay UE may send a UE report (e.g., remote UE report, end UE report, relay UE report, end/or the like) to a network node (e.g., core network node and/or a base station). For brevity, based on the other part of the present disclosure, redundant details will be omitted.

In an example, the relay UE A (and/or one or more downstream/upstream relay UEs of the relay UE A) may send the UE report. For example, when a new UE is added/removed in the topology of the relay UE A and/or when the topology changes, when the relay UE A assigns an IP address to a downstream UE of the relay UE A, when a downstream relay of the relay UE A assigns an IP address to a downstream UE of the relay UE A, when the relay UE A becomes aware of an IP address used by a downstream UE, the relay UE A may send the UE report.

In an example, the UE report may comprise a list of UE information. Each UE information of the list of the UE information may comprise at least one of an identifier (TMSI, remote UE ID, CP-PRUK, UP-PRUK, SUCI, GUTI, IMEI, and/or the like) of the UE, a type information (e.g., a relay UE type, a remote UE type, an end UE type, interim relay UE type, edge relay UE type, U2U relay type, U2N relay type, a downstream remote UE type and/or the like) of the UE, a list of linked UEs of the UE, a number of hop, amount of data sent/received by the UE, indication of whether multihop is used, an IP address assigned to the UE, a port information (e.g., a range of port number used by the UE) of the UE, and/or the like. For example, the UE report may comprise a first information and/or a second information. For example, the first information may comprise information of one or more UEs directly connected to the relay UE A. For example, the second information may comprise information of one or more UEs indirectly connected to the relay UE A (e.g., via one or more downstream relay UEs of the relay UE A). This may help the network node to process one or more packets for the RSC (or the PDU session). For example, based on IP address information and/or the port information, the network may be able to determine how many hops exist to a remote UE. Based on this, the UPF may reduce a processing time of a traffic for the remote UE and/or may prioritize processing of the traffic.

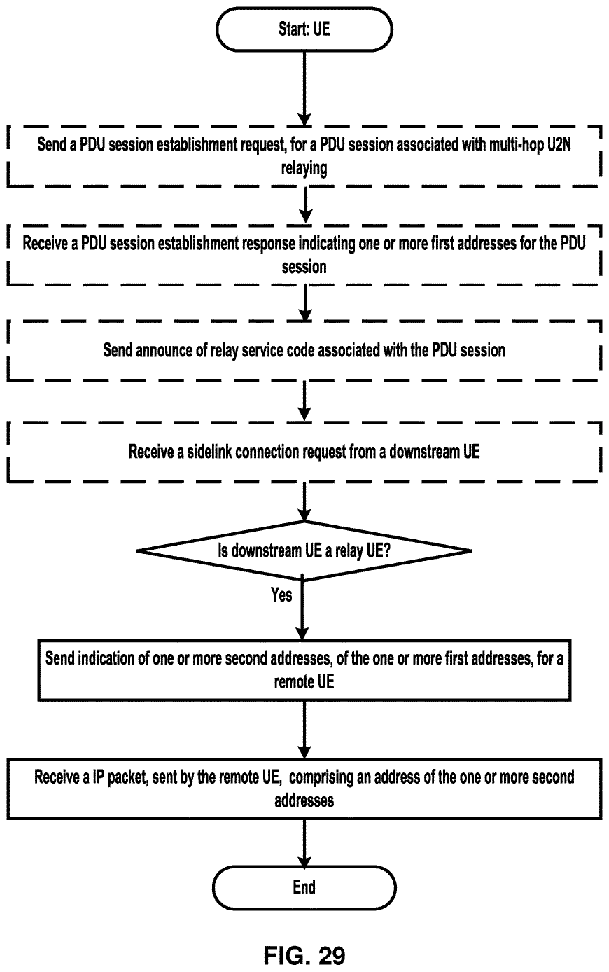

FIG. 29 depicts one example embodiment of the present disclosure.

In an example, a UE (e.g., a relay UE, a upstream relay UE, and/or the like) may send to a core network node (e.g., a SMF, a PCF, a AMF), a first message (e.g., PDU session establishment request) for a PDU session associated with a multihop relaying. For example, the first message may comprise a RSC 1.

In an example, the UE may receive from the core network node, a second message (e.g., a PDU session establishment accept). For example, the second message may indicate one or more first addresses for the PDU session and/or for the RSC 1 and/or for multihop relaying.

In an example, the UE may send a first sidelink message (e.g., a PC5 Prose Discovery message for announcement) to a downstream UE. For example, the first sidelink message may comprise the RSC 1 and/or indication of support of multihop relaying.

In an example, the UE may receive a second sidelink message (e.g., a PC5 Prose direct link establishment request) from a second UE (e.g., a downstream relay UE). For example, the second sidelink message may indicate whether the second UE supports a relaying operation for multihop and/or whether the second UE supports IP allocation.

In an example, the UE may determine whether the second UE supports multihop relaying and/or IP allocation for multihop relaying. In an example, the UE may send a third sidelink message to the second UE. Because the second UE supports multihop relaying and/or because the second UE supports IP allocation for multihop relaying, the third sidelink message may comprise at least one or more second addresses of the one or more first addresses. For example, the second UE may allocate a second address of the one or more second addresses to a remote UE connected to the second UE for multihop relaying. For example, one or more addresses (e.g., the first one or more addresses, the second one or more addresses) may be one or more IP address, one or more IP prefix, one or more NATed IP addresses, local IP addresses, one or more IP addresses linked (e.g., mapped) to a IP address assigned to the PDU session, one or more range of ports, and/or the like.

In an example, the UE may send to the core network node, information of the one or more addresses used by one or more downstream UEs of the first UE.

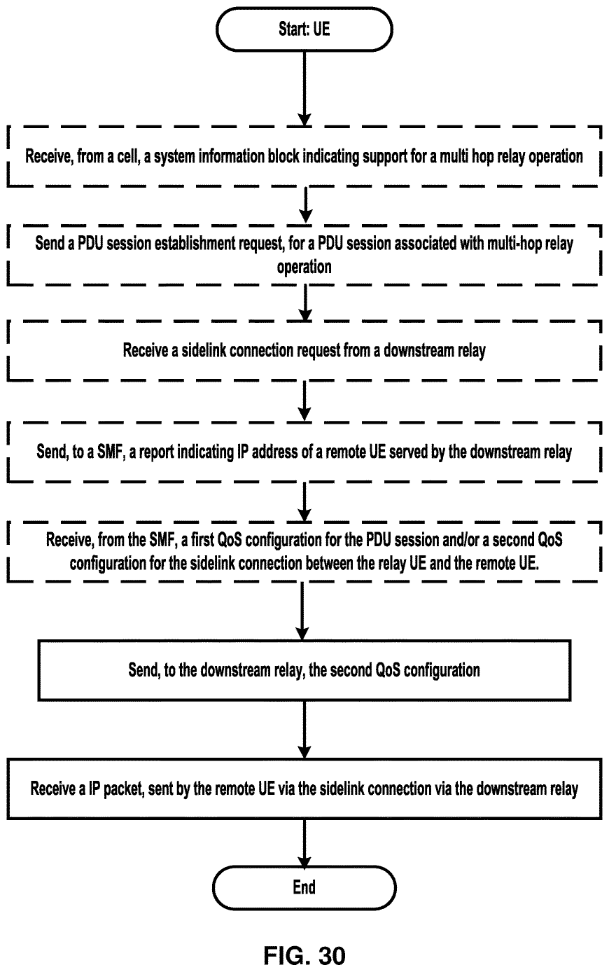

FIG. 30 depicts one example embodiment of the present disclosure.

In an example, a UE may receive from a cell, a message (e.g., a system information block) indicating that the cell (e.g., a basestation, a network) supports multihop relaying operation. In an example, the UE may send a PDU session establishment request to the cell, to establish a PDU session for multihop relaying. In an example, the UE may receive a sidelink connection request from a downstream relay. For example, the UE may receive from the downstream relay UE, information of one or more UEs connected to the downstream relay UE and/or one or more addresses allocated (used, assigned) by the one or more UEs. In an example, the UE may send to a network node (e.g., an SMF, a PCF, a AMF, and/or the like), a report message. For example, the report message may comprise the information (e.g., identifier) of the one or more UEs and/or the one or more addresses. In an example, the UE may receive from the network node, a first QoS configuration information for the PDU session and/or a second QoS configuration for one or more PC5 interfaces (and/or end-to-end sidelink connection between a remote UE and the UE) for multihop relaying. In an example, based on the second QoS configuration, the UE may send to the downstream relay UE (and/or one or more downstream UEs of the downstream relay UE) a message comprising updated QoS configuration, updated configuration and/or the second QoS configuration. In an example, the UE may receive from the one or more downstream UEs, one or more IP packets, via the downstream relay, using the second QoS configuration.

One or more embodiments of the present disclosure may be applicable to U2U relaying service. E.g., examples are described for providing a U2N service (e.g., a data traffic between a UE and an application server (network). The descriptions and/or examples may be applicable to a U2U service (e.g., data traffic among UEs, without traversing an application server (network)) by replacing the U2N service to the U2U service.

In an example, a first wireless relay device may send to a session management function (SMF), a session management message requesting a protocol data unit (PDU) session for multi-hop relaying. The first wireless relay device may receive from the SMF, a response message indicating one or more addresses for the PDU session. The first wireless relay device may determine, and based on receiving a first sidelink message from a second wireless relay device, one or more first addresses of the one or more addresses, allocated to the second wireless relay device. The first wireless relay device may send to the second wireless relay device, a second sidelink message indicating the one or more first addresses. The first wireless relay device may send and via the PDU session, a packet received from a remote wireless device via the second wireless relay device, wherein the packet indicates a first address of the one or more first addresses.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device.

In an example, a first wireless relay device may send to a SMF, a session management message requesting a PDU session, and may receive from the SMF, a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may support multihop relaying, wherein the multihop relaying is a data delivery via a plurality of wireless relay devices comprising at least the first wireless relay device and the second wireless relay device.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may receive from the remote wireless device and via the second wireless relay device, a packet comprising the first address, wherein the packet is sent over the PDU session to the network by the first wireless relay device.

In an example, a first wireless relay device may receive from a session management function (SMF), a response message indicating one or more addresses for a protocol data unit (PDU) session. The first wireless relay device may receive from the second wireless relay device, a sidelink connection request message indicating at least one of support for multihop relaying, or the second wireless relay device being a downstream relay device, or a remote wireless device connected to the second wireless relay device. The first wireless relay device may send to the second wireless relay device, a sidelink message indicating a first address, associated with the one or more addresses, of the remote wireless device connected to the second wireless relay device.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The sidelink message may further comprise at least one of a relay service code (RSC) associated with the PDU session, or an address allocation mode. The address allocation mode may indicate whether the second wireless relay device is allowed to allocate an address for the remote wireless device or whether the first wireless relay device allocates the address for the remote wireless device.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may send to a third wireless relay device, a second sidelink message indicating that the third wireless relay device is not allowed to allocate a second address for a third remote wireless device. The first wireless relay device may receive from the third remote wireless device via the third wireless relay device, a third sidelink message requesting allocation of a third address for the third remote wireless device. The first wireless relay device may send to the third remote wireless device via the third wireless relay device, a fourth sidelink message comprising the third address allocated to the third remote wireless device. The third sidelink message may request a wireless device-to-wireless device relay connection.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The sidelink message may comprise one or more first addresses that the second wireless relay device allocates to one or more remote wireless devices, wherein the one or more first addresses comprises the first address. The sidelink message may comprise at least one of a first indication that the first wireless relay device allocates a fourth address for a fourth remote wireless device connected to the second wireless relay device, or an address of the first wireless relay device, wherein the fourth remote wireless remote accesses the first wireless relay device for allocation of the address, using the address.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may receive from the second wireless relay device, a mapping information indicating mapping between one or more remote wireless devices connected to the second wireless relay device and one or more address of the one or more remote wireless devices.

In an example, a first wireless relay device may receive from a session management function (SMF), a response message indicating one or more addresses for a protocol data unit (PDU) session. The first wireless relay device may receive from the SMF, a sidelink QoS information for a PC5 QoS flow between the first wireless relay device and the remote wireless device via the second wireless relay device. The first wireless relay device may send to a second wireless relay device, a sidelink message indicating a first address, associated with the one or more addresses, of a remote wireless device connected to the second wireless relay device. The first wireless relay device may send to the second wireless relay device, a sidelink QoS information for a PC5 QoS flow between the first wireless relay device and the remote wireless device via the second wireless relay device, wherein the PC5 QoS flow is mapped to the PDU session. The sidelink QoS information may comprise a first PC5 QoS information for a first link between the remote wireless device and the second wireless relay device and a second PC5 QoS information for a second link between the first wireless relay device and the second wireless relay device.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may receive from the remote wireless device, an indication indicating a fifth remote wireless device is connected to the remote wireless device. The first wireless relay device may send to the remote wireless device, an indication indicating a maximum hop is reached for the fifth remote wireless device.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may send to the SMF, an information of address allocated for the multihop relaying.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may send and via the PDU session, a second packet received from a second remote wireless device via the second wireless relay device, wherein the second packet indicates a second address associated with the one or more first addresses.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The response message may comprise at least one of the one or more addresses, an information indicating the one or more ports, one or more address prefixes associated with the one or more addresses. The sidelink message may comprise at least one of the first address of the remote wireless device, or one or more first addresses associated with the one or more addresses.

In an example, a first wireless relay device may receive from a session management function (SMF), a response message indicating one or more addresses for a protocol data unit (PDU) session. The first wireless relay device may send to a second wireless relay device, a sidelink message indicating a first address, associated with the one or more addresses, of a remote wireless device connected to the second wireless relay device. The first wireless relay device may receive from the second wireless relay device and, an indication indicating at least one of that the second wireless relay device allocates the first address to the remote wireless device or that the second wireless relay device allocates the second address to the second remote wireless device.

In an example, a first wireless relay device may receive from a session management function (SMF), a response message indicating one or more addresses for a protocol data unit (PDU) session. The first wireless relay device may send to a second wireless relay device, a sidelink message indicating one or more first addresses, associated with the one or more addresses, of a remote wireless device connected to the second wireless relay device. For example, the one or more first addresses may be network address translated to the one or more addresses. For example, the first wireless relay device may receive from a remote UE via the second wireless relay device, a first packet. For example, the first packet may comprise a first address of the one or more first addresses. For example, the first wireless relay device may send a second packet to a network via the PDU session. For example, the second packet may be similar with the first packet, with modification. For example, the modification may be replacing the first address to one or more addresses. For example, the remote UE may not have a direct link to the first wireless relay device and/or may have a indirect link to the first wireless relay device (e.g., the remote UE has a connection to the first wireless relay device via the second wireless relay device).

What is claimed is:

1. A first relay wireless device comprising:
one or more processors; and
memory storing instructions that, when executed by the one or more processors, cause the first relay wireless device to:
receive, from a first wireless device, a message, indicating:
a first internet protocol (IP) address of the first wireless device for multihop relaying,
wherein the first wireless device is connected to a second wireless device, via the first relay wireless device and a second relay wireless device, using the multihop relaying; and
a device identifier of the first wireless device; and
send, to the second relay wireless device and based on the receiving, one or more parameters comprising the first IP address and the device identifier.

2. The first relay wireless device of claim 1, wherein the instructions further cause the first relay wireless device to send a ProSe discovery announcement message for the multihop relaying, wherein the ProSe discovery announcement message indicates a relay service code (RSC).

3. The first relay wireless device of claim 2, wherein the RSC is associated with the multihop relaying, and is not associated with a single-hop relaying.

4. The first relay wireless device of claim 2, wherein the one or more parameters indicate at least one of that the first wireless device is connected to the first relay wireless device, that the first relay wireless device supports the multihop relaying, or the RSC.

5. The first relay wireless device of claim 1, wherein the instructions further cause the first relay wireless device to receive from the second relay wireless device, a packet sent by the second wireless device, via a PC5 interface between the first relay wireless device and the second relay wireless device.

6. The first relay wireless device of claim 1, wherein the second wireless device is connected to the second relay wireless device via a second PC5 interface, and is not directly connected to the first relay wireless device.

7. The first relay wireless device of claim 1, wherein the one or more parameters further comprise at least one of a second device identifier indicating the first relay wireless device or a second IP address of the first relay wireless device.

8. The first relay wireless device of claim 1, wherein the first IP address is assigned by the first wireless device, based on the first relay wireless device sending an indication indicating whether the first relay wireless device does not support allocation of one or more IP addresses.

9. The first relay wireless device of claim 1, wherein the one or more parameters comprise a first PC5 QoS configuration and a second PC5 QoS configuration; wherein the first PC5 QoS configuration indicates one or more first QoS parameters for a hop between the first wireless device and the first relay wireless device, and the second PC5 QoS configuration indicates one or more second QoS parameters for one or more hops between the second wireless device and the first relay wireless device; and wherein the one or more first QoS parameters or the one or more second QoS parameters comprise at least one of a PC5 5GS QoS Identifier or packet delay budget.

10. The first relay wireless device of claim 9, wherein the first relay wireless device determines the first PC5 QoS configuration and the second PC5 QoS configuration, based on a number of hops.

11. A second relay wireless device comprising:
one or more processors; and
memory storing instructions that, when executed by the one or more processors, cause the second relay wireless device to:
receive, from a first relay wireless device, one or more parameters comprising:
a first internet protocol (IP) address of a first wireless device for multihop relaying, wherein the first wireless device is connected to a second wireless device, via the first relay wireless device and the second relay wireless device, using the multihop relaying; and
a device identifier of the first wireless device.

12. The second relay wireless device of claim 11, wherein the instructions further cause the second relay wireless device to receive, from the first relay wireless device, a ProSe discovery announcement message for the multihop relaying, wherein the ProSe discovery announcement message indicates a relay service code (RSC), and wherein the RSC is associated with the multihop relaying, and is not associated with a single-hop relaying.

13. The second relay wireless device of claim 11, wherein the instructions further cause the second relay wireless device to send, to the first relay wireless device, a packet sent by the second wireless device, via a PC5 interface between the first relay wireless device and the second relay wireless device, wherein the second wireless device is connected to the second relay wireless device via a second PC5 interface, and is not directly connected to the first relay wireless device.

14. The second relay wireless device of claim 11, wherein the one or more parameters further comprise at least one of a second device identifier indicating the first relay wireless device or a second IP address of the first relay wireless device, and wherein the first IP address is assigned by the first wireless device, based on the first relay wireless device sending an indication indicating whether the first relay wireless device does not support allocation of one or more IP addresses.

15. The second relay wireless device of claim 11, wherein the one or more parameters comprise a first PC5 QoS configuration and a second PC5 QoS configuration, and wherein the first PC5 QoS configuration indicates one or more first QoS parameters for a hop between the first wireless device and the first relay wireless device, and the second PC5 QoS configuration indicates one or more second QoS parameters for one or more hops between the second wireless device and the first relay wireless device.

16. A non-transitory computer-readable medium comprising instructions that, when executed by one or more processors of a first relay wireless device, cause the first relay wireless device to:
receive, from a first wireless device, a message, indicating:
a first internet protocol (IP) address of the first wireless device for multihop relaying, wherein the first wireless device is connected to a second wireless device, via the first relay wireless device and a second relay wireless device, using the multihop relaying; and
a device identifier of the first wireless device; and
send, to the second relay wireless device and based on the receiving, one or more parameters comprising the first IP address and the device identifier.

17. The non-transitory computer-readable medium of claim 16, wherein the instructions further cause the first relay wireless device to send a ProSe discovery announcement message for the multihop relaying, wherein the ProSe discovery announcement message indicates a relay service code (RSC), and wherein the RSC is associated with the multihop relaying, and is not associated with a single-hop relaying.

18. The non-transitory computer-readable medium of claim 17, wherein the one or more parameters indicate at least one of that the first wireless device is connected to the first relay wireless device, that the first relay wireless device supports the multihop relaying, or the RSC.

19. The non-transitory computer-readable medium of claim 16, wherein the instructions further cause the first relay wireless device to receive from the second relay wireless device, a packet sent by the second wireless device, via a PC5 interface between the first relay wireless device and the second relay wireless device, and wherein the second wireless device is connected to the second relay wireless device via a second PC5 interface, and is not directly connected to the first relay wireless device.

20. The non-transitory computer-readable medium of claim 16, wherein the one or more parameters further comprise at least one of a second device identifier indicating the first relay wireless device or a second IP address of the first relay wireless device, and wherein the first IP address is assigned by the first wireless device, based on the first relay wireless device sending an indication indicating whether the first relay wireless device does not support allocation of one or more IP addresses.
